(19) United States
(12) Patent Application Publication
(10) Pub. No.: US 2024/0244678 A1
(43) Pub. Date: Jul. 18, 2024

(54) METHODS AND APPARATUSES FOR MARITIME COMMUNICATION

(71) Applicant: Telefonaktiebolaget LM Ericsson (publ), Stockholm (SE)

(72) Inventors: Tianyi Li, Shanghai (CN); Shunqi Luan, Shanghai (CN); Zhaohua Chen, Beijing (CN)

(21) Appl. No.: 18/562,888

(22) PCT Filed: Jun. 9, 2021
(86) PCT No.: PCT/CN2021/099188

§ 371 Date: Nov. 21, 2023

(51) Int. Cl. H04W 76/10; H04W 40/24; H04W 84/00

(52) U.S. Cl. CPC H04W 76/10; H04W 40/24; H04W 84/005

(57) ABSTRACT

Methods and apparatuses are disclosed for maritime communication. According to an embodiment, a management server obtains topology information about at least part of a topology of a network comprising multiple maritime vessels. The management server determines, for one or more target maritime vessels of the network, configuration information for service addressing or packet routing, based on the topology information. The management server sends the configuration information for service addressing or packet routing to the one or more target maritime vessels.

### TECHNICAL FIELD

Embodiments of the disclosure generally relate to communication, and, more particularly, to methods and apparatuses for maritime communication.

### BACKGROUND

This section introduces aspects that may facilitate better understanding of the present disclosure. Accordingly, the statements of this section are to be read in this light and are not to be understood as admissions about what is in the prior art or what is not in the prior art.

Typically, a maritime vessel communicates with remote communication devices via terrestrial networks, or satellite networks when the maritime vessel is out of reach of the terrestrial networks or in other special conditions. For instance, when out of range of the terrestrial networks, machine-to-machine (M2M) devices on a maritime vessel may connect to a base station on the maritime vessel, which in turn is connected via a satellite network to a core network somewhere on land. The connection decision is based on the vessel's proximity to the terrestrial networks.

In the above typical solution, the maritime vessels, however, do not take advantage of other maritime vessels in close proximity to create opportunities for more cost effective and efficient communication therebetween and, ultimately, to the terrestrial networks. Also, it is not uncommon for a maritime vessel to lose satellite connectivity because the heading of the maritime vessel is such that a line of sight to the satellite from the satellite communication equipment onboard the maritime vessel becomes blocked by structures onboard the maritime vessel. Besides, limited by the technique, the satellite network cannot provide high speed service, like file transfer or video. Additionally, the typical solution does not take into account national jurisdictions with respect to the location of the maritime vessels, and associated potential ad hoc networks, to send and receive information both legally and efficiently.

Despite continued efforts to improve communication and reduce communication costs for a maritime vessel, a system is needed to mitigate the substantial hindrances for reliable radio communication from the maritime vessel to external networks such as the terrestrial networks.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for maritime communication. In particular, one of the problems to be solved by the disclosure is that the service continuity for inter-ship/node control plane (CP) and/or user plane (UP) packets in the existing solutions is poor.

According to a first aspect of the disclosure, there is provided a method performed by a management server. The method may comprise obtaining topology information about at least part of a topology of a network comprising multiple maritime vessels. The method may further comprise determining, for one or more target maritime vessels of the network, configuration information for service addressing or packet routing, based on the topology information. The method may further comprise sending the configuration information for service addressing or packet routing to the one or more target maritime vessels.

In this way, it is possible to facilitate inter-ship communication thereby improving service continuity for inter-ship traffic.

In an embodiment of the disclosure, the configuration information for service addressing can allow the one or more target maritime vessels to address services related to one or more different maritime vessels.

In an embodiment of the disclosure, obtaining the topology information [symbol] may comprise obtaining initial topology information about the topology of the network when the topology of the network is initially formed. Determining the configuration information for service addressing may comprise determining service addressing configurations for the multiple maritime vessels based on the initial topology information. The service addressing configurations may be sent to the multiple maritime vessels.

In an embodiment of the disclosure, obtaining the topology information may comprise: obtaining first topology information about the topology of the network at a first time; and obtaining second topology information about the topology of the network at a subsequent second time. There may be a change between the two topologies of the network. Determining the configuration information may comprise determining service addressing configuration updates for the one or more target maritime vessels, based on the first and second topology information. The service addressing configuration updates may be sent to the one or more target maritime vessels.

In an embodiment of the disclosure, there may be a change between the two topologies of the network because one or more of: a maritime vessel disconnects from the network due to mobility or breakdown of the maritime vessel; and a maritime vessel connects to the network due to mobility or restoration of the maritime vessel.

In an embodiment of the disclosure, the configuration information for service addressing that can allow a target maritime vessel to address a service related to a different maritime vessel may comprise: a retrieval condition related to the different maritime vessel; and an address of the service which corresponds to the retrieval condition.

In an embodiment of the disclosure, the retrieval condition related to the different maritime vessel may comprise: identification information of a network equipment which provides the service and is located at or serves the different maritime vessel.

In an embodiment of the disclosure, the retrieval condition related to the different maritime vessel may further comprise one or more of: an interface supported by the network equipment; and an indicator indicating whether or not the different maritime vessel is directly connected to the target maritime vessel in the topology of the network.

In an embodiment of the disclosure, the address of the service may be an Internet protocol (IP) related address or a domain name address.

In an embodiment of the disclosure, the domain name address may comprise: identification information of a relay terminal device located on the different maritime vessel; and a type of a network equipment which provides the service.

In an embodiment of the disclosure, the domain name address may further comprise one or more of: identification information of a maritime region where the different maritime vessel is located; and identification information of a network standard supported by the network equipment.

In an embodiment of the disclosure, the configuration information for service addressing may take a form of one or more domain name system (DNS) records.

In an embodiment of the disclosure, a number of the one or more target maritime vessels may be more than one. The configuration information for packet routing can allow a packet to be routed along a path of the more than one target maritime vessel to a different maritime vessel.

In an embodiment of the disclosure, obtaining the topology information may comprise obtaining third topology information about a part of the topology of the network. The part of the topology may be formed by the path and the different maritime vessel. Determining the configuration information for packet routing may comprise determining packet routing rules for the more than one target maritime vessel based on the third topology information. The packet routing rules may be sent to the more than one target maritime vessel.

In an embodiment of the disclosure, the multiple maritime vessels may comprise: a first set of maritime vessels each of which is provided with core network nodes; and a second set of maritime vessels each of which is provided with no core network nodes. CP traffic and UP traffic to/from the second set of maritime vessels may be transferred by one or more anchor nodes in the first set of maritime vessels.

In an embodiment of the disclosure, the CP traffic and the UP traffic to/from the second set of maritime vessels may be transferred by the same anchor node in the first set of maritime vessels.

In an embodiment of the disclosure, the CP traffic and the UP traffic to/from the second set of maritime vessels may be transferred by different anchor nodes in the first set of maritime vessels.

According to a second aspect of the disclosure, there is provided a method performed by a management server in a network. The network may comprise a first maritime vessel and two or more second maritime vessels. The first maritime vessel may act as an anchor node transferring CP traffic and/or UP traffic for the two or more second maritime vessels. The method may comprise determining, from the two or more second maritime vessels, a target second maritime vessel as a backup anchor node for substituting the anchor node. The method may further comprise sending, to the target second maritime vessel, available configuration information of the first maritime vessel that is required for acting as the anchor node.

In this way, it is possible to facilitate the recovery of the network in a case where the anchor node disconnects from the network.

In an embodiment of the disclosure, the method may further comprise receiving, from the first maritime vessel, at least part of the configuration information of the first maritime vessel that is required for acting as the anchor node.

In an embodiment of the disclosure, the configuration information may comprise: first configuration information for service addressing or packet routing; and second configuration information related to subscribers served by the first maritime vessel.

In an embodiment of the disclosure, the determining of the target second maritime vessel, the receiving of the at least part of the configuration information and the sending of the available configuration information may be performed when the first maritime vessel operates normally as the anchor node.

In an embodiment of the disclosure, the receiving of the at least part of the configuration information and the sending of the available configuration information may be performed at a predetermined time interval.

In an embodiment of the disclosure, the receiving of the at least part of the configuration information may be performed when the first maritime vessel operates normally as the anchor node. The determining of the target second maritime vessel and the sending of the available configuration information may be performed in response to a trigger event indicating that the first maritime vessel has disconnected from the network.

In an embodiment of the disclosure, the receiving of the at least part of the configuration information may be performed at a predetermined time interval.

In an embodiment of the disclosure, the available configuration information may comprise first configuration information for service addressing or packet routing that was previously provided to the first maritime vessel by the management server.

According to a third aspect of the disclosure, there is provided a method performed by a first relay terminal device at a first maritime vessel. The method may comprise receiving a data packet containing a protocol data unit (PDU) having a destination address. The method may further comprise determining whether or not a destination network equipment corresponding to the destination address is directly reachable. The method may further comprise, when determining that the destination network equipment is not directly reachable, transferring the data packet to a second relay terminal device at a second maritime vessel that is connected with the first maritime vessel.

In this way, it is possible to facilitate inter-ship communication thereby improving service continuity for inter-ship traffic.

In an embodiment of the disclosure, the method may further comprise, when determining that the destination network equipment is directly reachable, transferring the data packet to the destination network equipment.

In an embodiment of the disclosure, the data packet contains a CP message or a UP message.

In an embodiment of the disclosure, the CP message may be one of: an N1 non-access stratum (NAS) message; an N2 next generation application protocol (NGAP) message; an Xn message; and a GPRS tunneling protocol version 2 control plane (GTPv2-C) message.

In an embodiment of the disclosure, the data packet may contain one or more containers each of which comprises: a first indicator indicating a type of a CP message corresponding to the container; a second indicator indicating a length of contents of the container; and the contents of the container.

In an embodiment of the disclosure, the data packet may contain multiple containers. The data packet may further contain one or more of: a third indicator indicating a number of the multiple containers; and a fourth indicator indicating a number of optional information elements.

According to a fourth aspect of the disclosure, there is provided a management server. The management server may comprise at least one processor and at least one memory. The at least one memory may contain instructions executable by the at least one processor, whereby the management server may be operative to obtain topology information about at least part of a topology of a network comprising multiple maritime vessels. The management server may be further operative to determine, for one or more target maritime vessels of the network, configuration information for service addressing or packet routing, based on the topology information. The management server may be further operative to send the configuration information for service addressing or packet routing to the one or more target maritime vessels.

In an embodiment of the disclosure, the management server may be operative to perform the method according to the above first aspect.

According to a fifth aspect of the disclosure, there is provided a management server in a network. The network may comprise a first maritime vessel and two or more second maritime vessels. The first maritime vessel may act as an anchor node transferring CP traffic and/or UP traffic for the two or more second maritime vessels. The management server may comprise at least one processor and at least one memory. The at least one memory may contain instructions executable by the at least one processor, whereby the management server may be operative to determine, from the two or more second maritime vessels, a target second maritime vessel as a backup anchor node for substituting the anchor node. The management server may be further operative to send, to the target second maritime vessel, available configuration information of the first maritime vessel that is required for acting as the anchor node.

In an embodiment of the disclosure, the management server may be operative to perform the method according to the above second aspect.

According to a sixth aspect of the disclosure, there is provided a first relay terminal device at a first maritime vessel. The first relay terminal device may comprise at least one processor and at least one memory. The at least one memory may contain instructions executable by the at least one processor, whereby the first relay terminal device may be operative to receive a data packet containing a PDU having a destination address. The first relay terminal device may be further operative to determine whether or not a destination network equipment corresponding to the destination address is directly reachable. The first relay terminal device may be further operative to, when determining that the destination network equipment is not directly reachable, transfer the data packet to a second relay terminal device at a second maritime vessel that is connected with the first maritime vessel.

In an embodiment of the disclosure, the first relay terminal device may be operative to perform the method according to the above third aspect.

According to a seventh aspect of the disclosure, there is provided a computer program product. The computer program product may comprise instructions which when executed by at least one processor, cause the at least one processor to perform the method according to any of the above first to third aspects.

According to an eighth aspect of the disclosure, there is provided a computer readable storage medium. The computer readable storage medium may comprise instructions which when executed by at least one processor, cause the at least one processor to perform the method according to any of the above first to third aspects.

According to a ninth aspect of the disclosure, there is provided a management server. The management server may comprise an obtaining module for obtaining topology information about at least part of a topology of a network comprising multiple maritime vessels. The management server may further comprise a determination module for determining, for one or more target maritime vessels of the network, configuration information for service addressing or packet routing, based on the topology information. The management server may further comprise a sending module for sending the configuration information for service addressing or packet routing to the one or more target maritime vessels.

According to a tenth aspect of the disclosure, there is provided a management server in a network. The network may comprise a first maritime vessel and two or more second maritime vessels. The first maritime vessel may act as an anchor node transferring CP traffic and/or UP traffic for the two or more second maritime vessels. The management server may comprise a determination module for determining, from the two or more second maritime vessels, a target second maritime vessel as a backup anchor node for substituting the anchor node. The management server may further comprise a sending module for sending, to the target second maritime vessel, available configuration information of the first maritime vessel that is required for acting as the anchor node.

According to an eleventh aspect of the disclosure, there is provided a first relay terminal device at a first maritime vessel. The first relay terminal device may comprise a reception module for receiving a data packet containing a PDU having a destination address. The first relay terminal device may further comprise a determination module for determining whether or not a destination network equipment corresponding to the destination address is directly reachable. The first relay terminal device may further comprise a transferring module for, when determining that the destination network equipment is not directly reachable, transferring the data packet to a second relay terminal device at a second maritime vessel that is connected with the first maritime vessel.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating a scenario of maritime communication;

FIG. 2 is a diagram illustrating an exemplary communication system into which an embodiment of the disclosure is applicable;

FIG. 3 is a diagram illustrating another exemplary communication system into which an embodiment of the disclosure is applicable;

FIG. 4 is a diagram illustrating an exemplary maritime network in which an embodiment of the disclosure is applicable;

FIG. 5 is a diagram illustrating an exemplary maritime network in which an embodiment of the disclosure is applicable;

FIG. 6 is a flowchart illustrating a method performed by a management server according to an embodiment of the disclosure;

FIG. 7 is a flowchart for explaining the method of FIG. 6;

FIG. 8 is a diagram illustrating an exemplary scenario in which an embodiment of the disclosure is applicable;

FIG. 9 is a flowchart for explaining the method of FIG. 6;

FIG. 10 is a flowchart for explaining the method of FIG. 6;

FIG. 11 is a flowchart illustrating a method performed by a management server according to an embodiment of the disclosure;

FIG. 12 is a flowchart illustrating a method performed by a management server according to an embodiment of the disclosure;

FIG. 13 is a diagram illustrating an exemplary scenario in which an embodiment of the disclosure is applicable;

FIG. 14 is a flowchart illustrating a method performed by a first relay terminal device according to an embodiment of the disclosure;

FIG. 15 is a flowchart illustrating a method performed by a first relay terminal device according to an embodiment of the disclosure;

FIG. 16 is a diagram illustrating an exemplary configuration for a maritime network in which an embodiment of the disclosure is applicable;

FIG. 17 is a diagram for explaining some of the configuration of FIG. 16;

FIG. 18 is a diagram illustrating a control plane protocol stack usable in an embodiment of the disclosure;

FIG. 19 is a diagram illustrating a user plane protocol stack usable in an embodiment of the disclosure;

FIGS. 20A-20B are flowcharts illustrating an exemplary process according to an embodiment of the disclosure;

FIG. 21 is a block diagram showing an apparatus suitable for use in practicing some embodiments of the disclosure;

FIG. 22 is a block diagram showing a management server according to an embodiment of the disclosure;

FIG. 23 is a block diagram showing a management server according to an embodiment of the disclosure; and

FIG. 24 is a block diagram showing a first relay terminal device according to an embodiment of the disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

In the existing commercial 3rd generation partnership project (3GPP) terrestrial networks such as long term evolution (LTE)/new radio (NR) networks, the locations of base stations and network topology are typically fixed. All nodes are well designed to exchange with each other via available and stable transport layer and Internet protocol (IP) layer connection. However, maritime networks do not have this precondition.

Since inter-ship/node communication depends on application servers, network functions and user equipments (UEs) via radio access, inter-ship/node control plane (CP) messages and user plane (UP) packets may be transferred and exchanged via this connection in application level, network function level, or UE session level. In addition, inter-ship communication has the following differences from the traditional terrestrial communication: 1) transport/IP routing is relatively unstable in inter-ship communication; 2) radio resource control (RRC) non-access stratum (NAS) session packets have to undergo disconnection and reestablishment from time to time in inter-ship communication; 3) IP allocation and discovery in inter-ship communication have not been designed to be intelligent; and 4) routing rules for chain path switching or transitioning in inter-ship communication are complex.

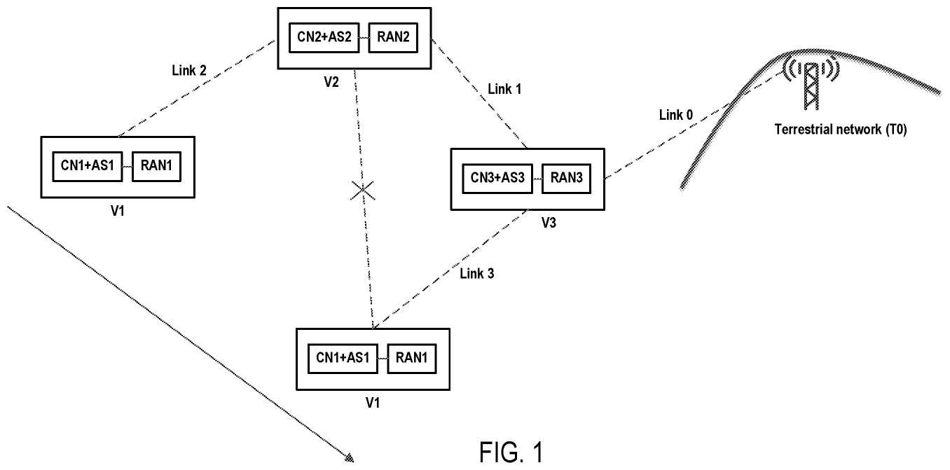

FIG. 1 is a diagram illustrating an exemplary scenario of maritime communication. As shown, there are three maritime vessels each of which is provided with a radio access network (RAN), a core network (CN) and an applications server (AS). These vessels may be connected to form a maritime network. The vessel V1 has connected to the terrestrial network T0 via the vessels V2 and V3. The UE on the vessel V1 may trigger measurement and report behavior according to the configuration from RAN2. The radio signal strengths (e.g. reference signal receiving power (RSRP) or reference signal receiving quality (RSRQ) or signal to interference plus noise ratio (SINR)) from RAN2 and neighboring cells may be measured. Suppose the vessel V1 moves in the direction indicated by the arrow in FIG. 1. Then, due to the mobility, when the radio signal strength from RAN2 drops out of a certain stable signal strength, the UE may have radio link failure or RRC release. So the UE may trigger cell re-selection to RAN3 according to the movement direction.

In the existing maritime network, since no direct IP and transport layer connection between the core networks CN2 and CN3 (e.g. the inter-node application layer is not available for X2 or S1 or S10, etc.), the inter-ship connections are blocked in mobility management and session management. Thus, the cell re-selection to RAN3 is not an RRC re-connection, but is a new initial attach/mobility registration to the new core network CN3. Thus, when disconnection happens due to e.g. mobility, since the UE has to perform deregistration and registration between different core networks that are unknown or unavailable for each other in the maritime network, there may be a long time (larger than some seconds/minutes) of disconnection in application layer and transport layer, which may be not acceptable.

Therefore, when the UE on the vessel V1 moves from V2 area to V3 area, it would be desirable for the UE to trigger mobility in radio access cell level or in mobility management entity (MME)/access and mobility management function (AMF) tracking area list (TAL) level.

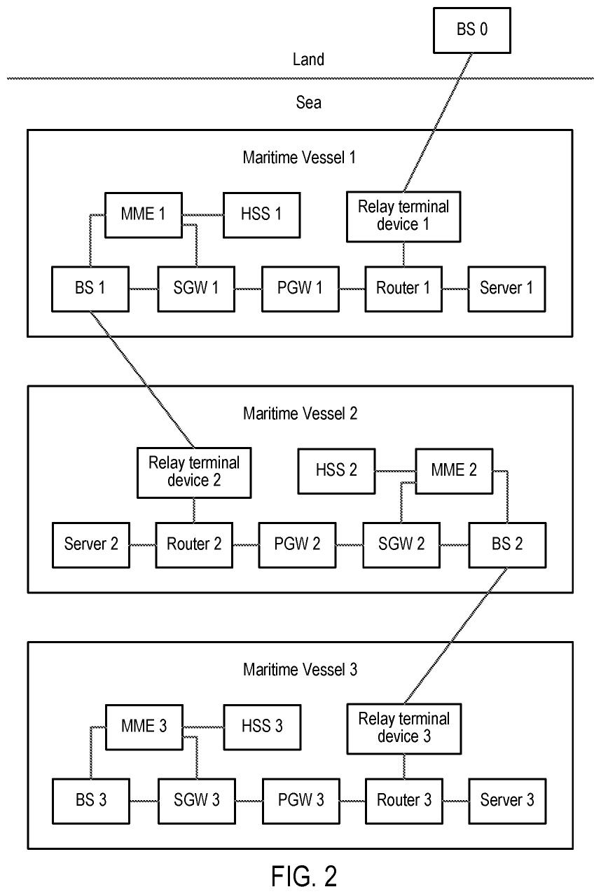

The present disclosure proposes an improved solution for maritime communication. Hereinafter, the solution will be described in detail with reference to FIGS. 2-24.

FIG. 2 is a diagram showing an exemplary communication system into which an embodiment of the disclosure is applicable. As shown, the communication system comprises a base station on land and three maritime vessels (Maritime vessel 1, Maritime vessel 2 and Maritime vessel 3). Each maritime vessel comprises a base station, a mobility management entity (MME), a serving gateway (SGW), a packet data network (PDN) gateway (PGW), a home subscriber server (HSS), a router, a relay terminal device and a server (e.g. an application server or a mesh server). The base station can provide radio access communication links to terminal devices that are within its communication service cell. Examples of the base station may include, but not limited to, an evolved node B (eNB), a next generation node B (gNB), etc. For example, in a case where an eNB is deployed at a maritime vessel, when compared with using other technologies such as WiFi to provide access for another maritime vessel, a super maritime wireless network with extended coverage (>100 km) can be provided without enhancement of terrestrial base stations. Only the base station on land is shown for brevity to represent the terrestrial network. The MME, the SGW, the PGW and the HSS are merely exemplary components of the core network for illustration purpose. Some components of the core network may be omitted for brevity. Some additional network elements such as an enterprise network management (ENM), an automatic identification system (AIS) system and an operation support system (OSS) may also be contained in the communication system. The term mesh server may refer to a server which employs at least some aspect (e.g. peer discovering) of mesh technology. Although three maritime vessels are shown, the number of the maritime vessels may be two or more than three. The terms “maritime vessel” and “ship” may be interchangeably used herein. The number of each entity mentioned above in the maritime vessel may be more than one.

The relay terminal device 1 at Maritime vessel 1 can access the base station 0 on land and also act as an access point for other terminal device(s) at Maritime vessel 1. For example, any one of the relay terminal devices shown in FIG. 2 may be a customer premise equipment (CPE) capable of converting signals of one radio access technology (RAT) to signals of another RAT, such as converting LTE signals to WiFi signals. It is also possible that other terminal device(s) at Maritime vessel 1 may directly access the base station 0 on land. The relay terminal device 1 can be configured not to access the base station 1. The relay terminal device 1 can also relay traffic (e.g. data and/or signaling) between the core network 1 or the server 1 at Maritime vessel 1 and the terrestrial network. The router 1 at Maritime vessel 1 can route traffic between the core network 1, the relay terminal device 1 and the server 1 at Maritime vessel 1.

Similarly, the relay terminal device 2 at Maritime vessel 2 can access the base station 1 at Maritime vessel 1 and also act as an access point for other terminal device(s) at Maritime vessel 2. The relay terminal device 2 can be configured not to access the base station 2. The relay terminal device 2 can also relay traffic between the core network 2 or the server 2 at Maritime vessel 2 and the core network 1 or the server 1 at Maritime vessel 1. The router 2 at Maritime vessel 2 can route traffic between the core network 2, the relay terminal device 2 and the server 2 at Maritime vessel 2.

Likewise, the relay terminal device 3 at Maritime vessel 3 can access the base station 2 at Maritime vessel 2 and also act as an access point for other terminal device(s) at Maritime vessel 3. The relay terminal device 3 can be configured not to access the base station 3. The relay terminal device 3 can also relay traffic between the core network 3 or the server 3 at Maritime vessel 3 and the core network 2 or the server 2 at Maritime vessel 2. The router 3 at Maritime vessel 3 can route traffic between the core network 3, the relay terminal device 3 and the server 3 at Maritime vessel 3. In this way, a multi-hop network can be formed with the topology and coverage being self-organized.

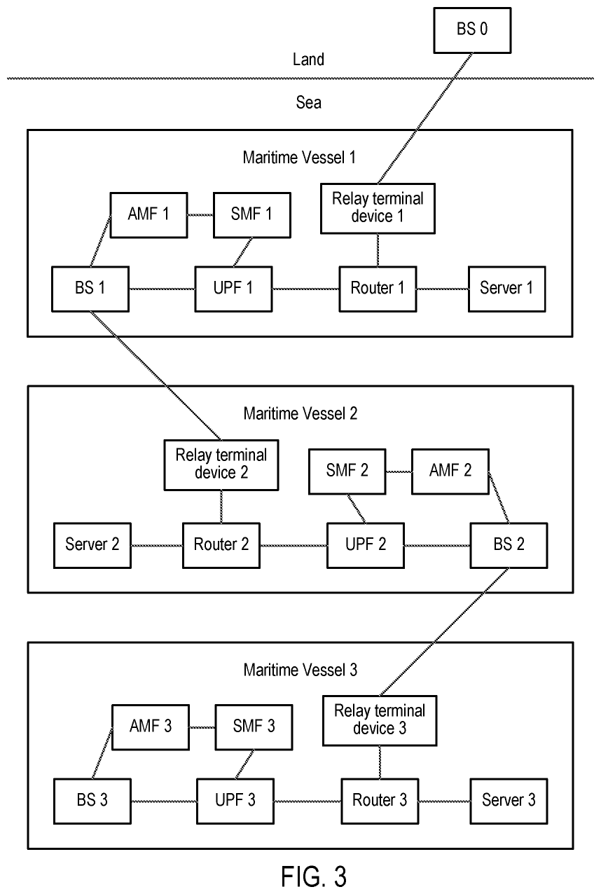

Although the core network in FIG. 2 is shown as part of an evolved packet core (EPC), any other suitable core network such as 5th generation core (5GC) may be used as the core network. FIG. 3 illustrates another exemplary communication system in which 5GC is used instead of EPC. As shown in FIG. 3, the core network on each maritime vessel comprises an AMF, a session management function (SMF) and a user plane function (UPF). These network functions are merely exemplary components of the core network for illustration purpose. Some components of the core network may be omitted for brevity. Therefore, the specific terms used herein do not limit the present disclosure only to the communication system related to the specific terms, which however can be more generally applied to other communication systems.

The term terminal device may also be referred to as, for example, device, access terminal, user terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

It should be noted that the present disclosure is not limited to the above scenario in which each of the maritime vessels in the maritime network is provided with a core network. As another scenario, some maritime vessel(s) in the maritime network may be provided with core network(s), while the other maritime vessel(s) in the maritime network may be provided with no core network(s). In both scenarios, the CP traffics and/or UP traffics to/from all the maritime vessels may be transferred by the same core network which may be provided on land or on one of the maritime vessels in the maritime network. The land (or terrestrial) network or the maritime vessel in which the same core network is provided may be called an anchor. The configuration where the land network acts as the anchor may be referred to as centralized topology. The configuration where a maritime vessel acts as the anchor may be referred to as distributed topology. The anchor provided with the network equipment (e.g. an AMF or an MME) responsible for transferring the CP traffics to/from all the maritime vessels may be called a CP anchor. The anchor provided with the network equipment (e.g. a UPF or a PGW) responsible for transferring the UP traffics to/from all the maritime vessels may be called a UP anchor. The CP anchor and the UP anchor may be the same anchor, or may be separate from each other. For example, in the centralized topology, different land networks may act as the CP anchor and the UP anchor respectively. In the distributed topology, different maritime vessels may act as the CP anchor and the UP anchor respectively.

The IP routes may be independently managed for CP traffics and UP traffics. For example, the IP routes for CP traffics may be changed regardless of the IP routes for UP traffics, for the purpose of less selection latency rather than more traffic capacity chain, or less hops in geographical positioning rather than quality of service (QoS) of transport of UP traffics. Note that the anchor may be statically determined or dynamically changed depending on the requirements of the maritime network. Also note that the centralized topology and the distributed topology are not only for 3GPP core network function but also for any over-the-top (OTT) or application layer CP signaling/UP protocol data unit (PDU).

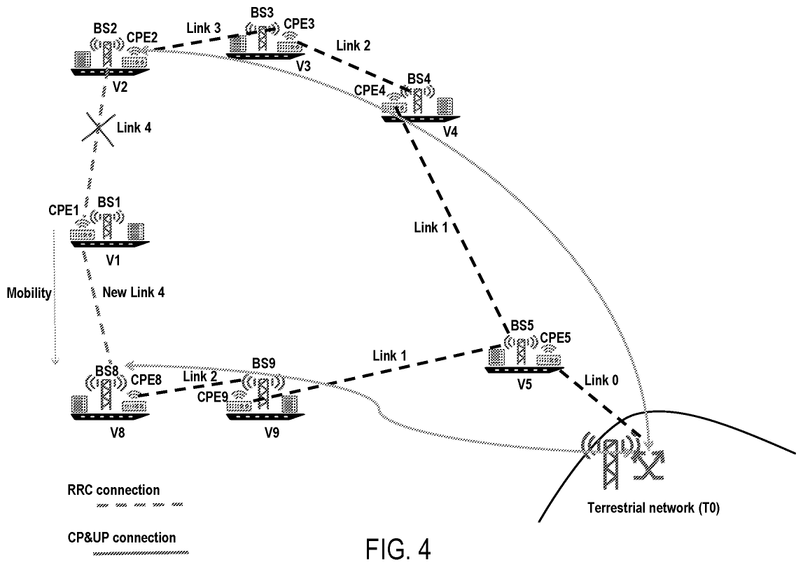

FIG. 4 illustrates an exemplary example of the centralized topology. As shown, in this example, both the CP (e.g. NAS) anchor and the UP (e.g. session data network name (DNN)/access point name (APN)) anchor are the same centralized anchor on land. The centralized anchor may be responsible for the network-level duty of transport and IP layers. For example, any application request/response/packets delivery between different endpoints (e.g. V8 and V2) for a mobility node (e.g. V1 which hands over from V2 to V8 due to mobility) may be achieved via the centralized anchor. This topology may be applicable for a more stable connection scenario such as offshore area for quicker path switch.

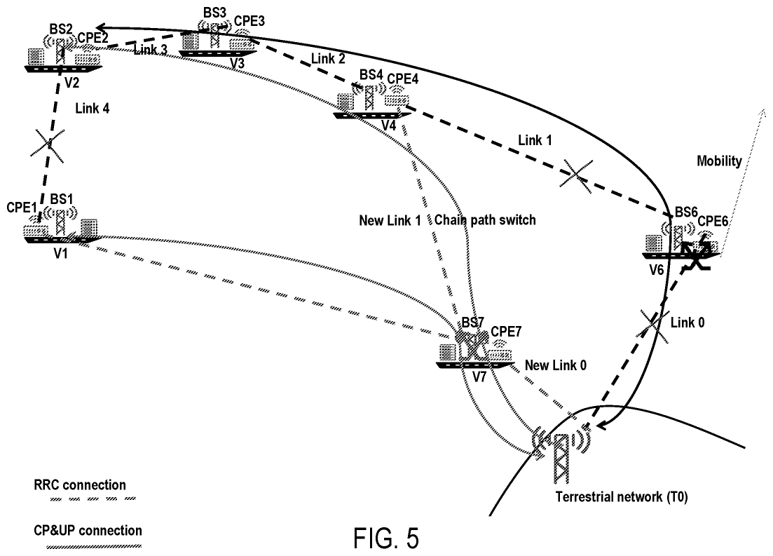

FIG. 5 illustrates an exemplary example of the distributed topology. As shown, in this example, both the CP (e.g. NAS) anchor and the UP (e.g. session data network name (DNN)/access point name (APN)) anchor are the anchor V6 initially. In a case where V6 disconnects from the terrestrial network due to mobility, V7 may be selected as the new anchor. Thus, in this example, the distributed topology is dynamically changed depending on mobility change. Note that the distributed topology may also be dynamically changed depending on service change (e.g. DNN/APN change or deployment change, etc.). When the anchor changes from V6 to V7, the path of chain switches (from V4-V6-T0 to V4-V7-T0). The transport and IP layers of the corresponding endpoints of the maritime network may be updated. The leaves node such as V1 may determine the best path switch according to less hops and positioning information (e.g. global navigation satellite system (GNSS) information which may be obtained from an AIS system on V1). As a result, new radio link as well as CP and UP links to V7 may be established as an intelligent topology modification.

It should be noted that the centralized topology and the distributed topology may exit in the same maritime network. For example, some maritime vessels in the maritime network may employ the centralized topology and the other maritime vessels in the maritime network may employ the distributed topology (e.g. one or more UP anchors may be distributed near the edge of the maritime network). Depending on the modem and terminal capability of CPE and network deployment, tree topology may be not the only topology, and star or bus topology may be additionally included.

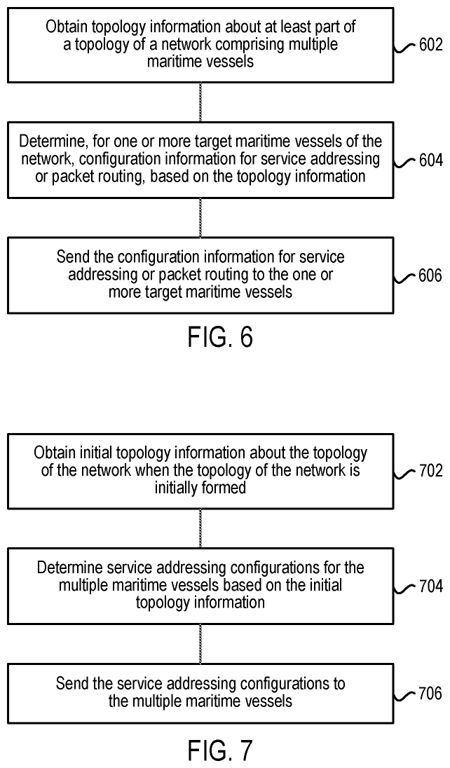

FIG. 6 is a flowchart illustrating a method performed by a management server according to an embodiment of the disclosure. For example, a server on land or on a fixed offshore platform may act as the management server. Alternatively, a server (e.g. a mesh server) on a maritime vessel provided with a core network may act as the management server. Note that the management server and some network node (or network function) described herein can be implemented either as a network element on a dedicated hardware, as a software instance running on a dedicated hardware, or as a virtualized function instantiated on an appropriate platform, e.g. on a cloud infrastructure. At block 602, the management server obtains topology information about at least part of a topology of a network comprising multiple maritime vessels. For example, the network may comprise a maritime network and a terrestrial network. The maritime network may comprise the multiple maritime vessels each of which is provided with a base station, a relay terminal device (e.g. a CPE), a router and a server (e.g. a mesh server). In a case where a maritime vessel is provided with a core network, in addition to packet routing functionality, the router at a maritime vessel may have a service addressing component which allows the maritime vessel to address services related to one or more different maritime vessels. As an exemplary example, the service addressing component may take the form of a DNS server. On the other hand, in a case where a maritime vessel is provided with no core network, the router at the maritime vessel does not need to have the service addressing component.

As an example, the multiple maritime vessels may comprise: a first set of maritime vessels each of which is provided with core network nodes; and a second set of maritime vessels each of which is provided with no core network nodes. In this case, CP traffic and UP traffic to/from the second set of maritime vessels may be transferred by one or more anchor nodes in the first set of maritime vessels or by a terrestrial network. As another example, each of the multiple maritime vessels may be provided with core network nodes. In this case, one or more anchor nodes may be responsible for transferring CP traffic and UP traffic to/from the other maritime vessels. In either of the two examples, the CP traffic and the UP traffic to/from the second set of maritime vessels may be transferred by the same anchor node in the first set of maritime vessels or by a terrestrial network. Alternatively, the CP traffic and the UP traffic to/from the second set of maritime vessels may be transferred by different anchor nodes in the first set of maritime vessels or by different terrestrial networks.

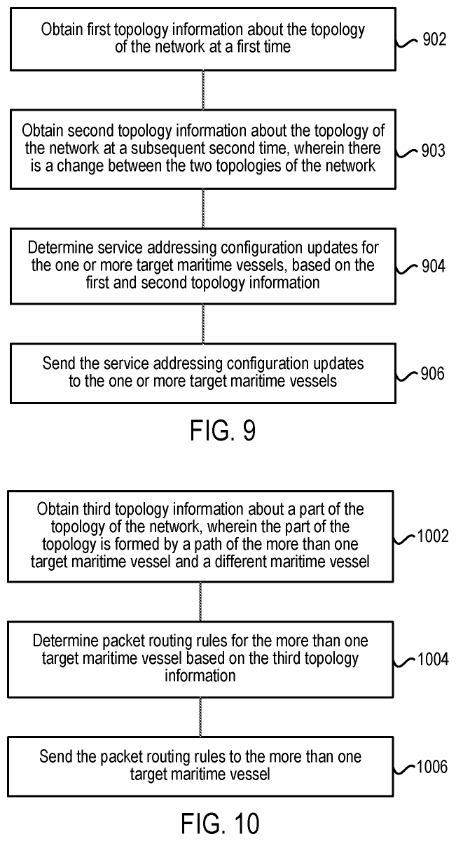

There may be three options for implementing the method of FIG. 6. As the first option, block 602 may be implemented as block 702 of FIG. 7. As the second option, block 602 may be implemented as blocks 902 and 903 of FIG. 9. As the third option, block 602 may be implemented as block 1002.

At block 604, the management server determines, for one or more target maritime vessels of the network, configuration information for service addressing or packet routing, based on the topology information. The configuration information for service addressing (e.g. service addressing configuration or service addressing configuration update) can allow the one or more target maritime vessels to address services related to one or more different maritime vessels. As an exemplary example, the configuration information for service addressing may take the form of one or more DNS records. The configuration information for packet routing may be applicable to the case where the number of the one or more target maritime vessels is more than one. In this case, the configuration information for packet routing can allow a packet to be routed along a path of the more than one target maritime vessel to a different maritime vessel. As an exemplary example, the configuration information for packet routing may take the form of packet routing rules. In the above first option, block 604 may be implemented as block 704. In the above second option, block 604 may be implemented as block 904. In the above third option, block 604 may be implemented as block 1004. At block 606, the management server sends the configuration information for service addressing or packet routing to the one or more target maritime vessels. In the above first option, block 606 may be implemented as block 706. In the above second option, block 606 may be implemented as block 906. In the above third option, block 606 may be implemented as block 1006. With the method of FIG. 6, it is possible to facilitate inter-ship communication thereby improving service continuity for inter-ship traffic, since the configuration information for service addressing or packet routing can be actively provided by the management server.

Now the details of the methods of FIGS. 7, 9 and 10 corresponding to the above first, second and third option will be described respectively. In the above first option, at block 702, the management server obtains initial topology information about the topology of the network when the topology of the network is initially formed. As an example, the server (e.g. a mesh server) at every maritime vessel in the network may send the identification information of the maritime vessel and connection relationship (relative to the connected maritime vessel(s)) to the management server (e.g. via mesh application message). Then, with the received information, the management server may find out how these maritime vessels are connected with each other, thereby determining the topology of the network. Note that the topology information may be obtained in any other suitable manner.

At block 704, the management server determines service addressing configurations for the multiple maritime vessels based on the initial topology information. That is, in the first option, the one or more target maritime vessels mentioned at block 604 are the multiple maritime vessels and the configuration information for service addressing mentioned at block 604 is the service addressing configurations. For example, a service addressing configuration may be determined for each maritime vessel of the multiple maritime vessels, such that the determined service addressing configuration can allow the maritime vessel to address services related to one or more different maritime vessels which may be neighbors (e.g. directly and optionally indirectly) adjacent to the maritime vessel in the topology of the network. For a target maritime vessel (e.g. any one of the multiple maritime vessels in the first option), the service addressing configuration that can allow the target maritime vessel to address a service related to a specific different maritime vessel may comprise a retrieval condition related to the different maritime vessel, and an address of the service which corresponds to the retrieval condition.

For example, the retrieval condition related to the different maritime vessel may at least comprise identification information of a network equipment which provides the service and is located at or serves the different maritime vessel. Examples of the network equipment may include a base station, a core network element, and a relay terminal device (e.g. a CPE). Note that in the case where the network equipment is a core network element, depending on whether or not this different maritime vessel is provided with a core network, the network equipment may be located at this different maritime vessel or at another maritime vessel serving this different maritime vessel. Optionally, the retrieval condition related to the different maritime vessel may further comprise one or more of: an interface supported by the network equipment (e.g. the interface may be N4 if the network equipment is an SMF); and an indicator indicating whether or not the different maritime vessel is directly connected to the target maritime vessel in the topology of the network. The information related to network equipments at every maritime vessel (e.g. the identification information of the network equipment, the interface supported by the network equipment, etc.) can be known to the management server since it can be shared with the management server, similarly to the identification information of the maritime vessel and connection relationship mentioned above.

The address of the service may be an IP related address (e.g. an IP address, or an IP address and port) or a domain name address. As will be described later, at a maritime vessel of the network, the base station, the core network (if any) and the router may constitute an internal network. The internal IP addresses of the base station and core network elements of the core network (if any) may be assigned by the router. The relay terminal device (e.g. a CPE) and the server (e.g. a mesh server) may belong to the external network. The IP addresses of the relay terminal device and the server may be assigned by the terrestrial network (e.g. a PGW or UPF). For a network equipment (e.g. the base station or the core network element) in the internal network, the router and the relay terminal device may work together to associate the internal IP address and port of this network equipment with an external IP address and port such that this network equipment can communicate with another maritime vessel by using the external IP address and port.

The IP related address may be used for the case of statically assigned IP address. In this case, the IP address or the IP address and port may be directly used as the address of the service. The domain name address may be used for the case of dynamically assigned IP address. For a target maritime vessel (e.g. any one of the multiple maritime vessels in the first option), the domain name address that can allow the target maritime vessel to address a service related to a specific different maritime vessel may at least comprise identification information of a relay terminal device located on the different maritime vessel and a type of a network equipment which provides the service (e.g. the type may be “amfi” if the provided service is access and mobility management). Optionally, the domain name address may further comprise one or more of: identification information of a maritime region where the different maritime vessel is located; and identification information of a network standard supported by the network equipment (e.g. the identification information may be “5gc” if the network equipment is an AMF). At block 706, the management server sends the service addressing configurations to the multiple maritime vessels. For example, the service addressing configuration for each maritime vessel of the multiple maritime vessels may be sent to the router at the maritime vessel to be used by the service addressing component contained in the router.

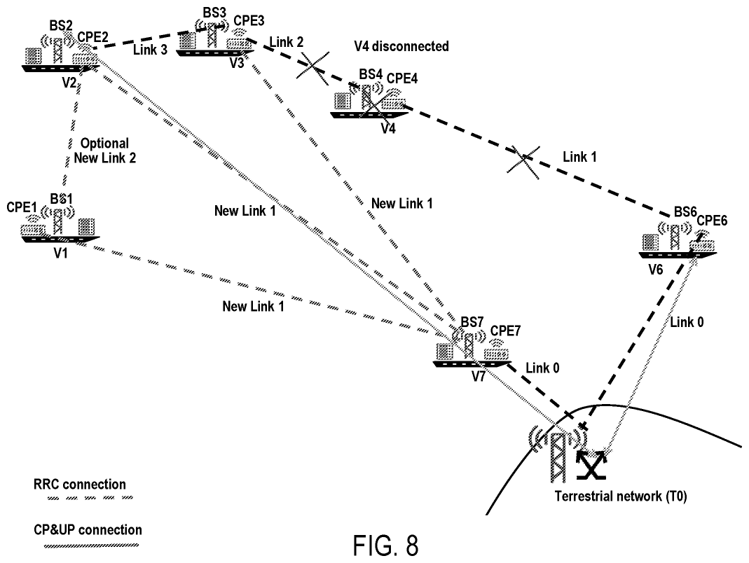

For ease of explanation, the scenario shown in FIG. 8 is taken as an example. In this scenario, suppose that when the topology of the network is initially formed, the connection relationship between respective maritime vessels is as follows: T0 is connected with V7 and V6; V6 is connected with V4; V4 is connected with V3, V3 is connected with V2; and V2 is connected with V1. The initial topology information representing the above connection relationship may be obtained at block 702. Then, service addressing configurations for V1, V2, V3, V4, V6 and V7 may be determined based on the initial topology information at block 704. For example, the service addressing configuration determined for V3 may be represented by the following Table 1.

TABLE 1
Service addressing configuration for V3 (for the initial time)

| | | order | prefix | flags | Address | regexp replacement |
|---|---|---|---|---|---|---|
| IN | NAPTR | 100 | “a” | 1 | regiona6.amfi.5gc.cpe4.3gppnetwork.org | topon.n14.amf4.nodes.$ORIGIN. |
| IN | NAPTR | 30 | “a” | 1 | regiona6.amfi.5gc.cpe2.3gppnetwork.org | topon.n14.amf2.nodes.$ORIGIN. |

As shown in Table 1, the service addressing configuration for V3 takes the form of 2 DNS records corresponding to V4 and V2 (which are 2 neighbors directly connected with V3 in the topology of the network) respectively. Note that only the services provided by AMFs on V4 and V2 are shown in Table 1 for illustration purpose. The services provided by other network equipments on V4 and V2 may also be contained in the service addressing configuration. For the first record corresponding to V4, the “regexp replacement” representing the retrieval condition related to V4 takes the form of “topon.n14.amf4.nodes.$ORIGIN.”, where “amf4” is the identification information of the AMF which provides the service and is located at V4, “n14” is the interface supported by the AMF, and “topon” indicates that V4 is directly connected to the target maritime vessel V3 in the topology of the network. The “Address” representing the address of the service which corresponds to the retrieval condition takes the form of “regiona6.amfi.5gc.cpe4.3gppnetwork.org”, where “cpe4” is the identification information of the CPE located on V4, “amfi” is the type of the network equipment which provides the service, “5gc” is the identification information of the network standard supported by the network equipment, and “regiona6” is the identification information of the maritime region where V4 is located. The “NAPTR” in Table 1 refers to naming authority pointer which is a type of resource record in the domain name system of the Internet. The “order” in Table 1 indicates the priority level of a record in a case where multiple records are returned for a retrieval condition. For example, the smaller the value of the “order” is, the higher priority a record has. The “prefix” in Table 1 may be used as a keyword. For example, prefix “a” may represent a core network element. The “flags” in Table 1 indicates whether the service is currently reachable. For example, the value “1” of the “flags” may indicate the reachable status and the value of “0” may indicate the unreachable status. The service addressing configuration shown in Table 1 may be provided to the service addressing component (e.g. a DNS server) on V3 at block 706.

As an exemplary example, for the case of statically assigned IP address, the service addressing configuration determined for V3 may be represented by the following Table 2.

TABLE 2
Service addressing configuration for V3 (for the initial time)

| | | order | prefix | flags | Address | regexp replacement |
|---|---|---|---|---|---|---|
| IN | AAAA | 100 | “a” | 1 | 2001:db3:1:27 | topon.n14.amf4.nodes.$ORIGIN. |
| IN | A | 30 | “a” | 1 | 192.0.2.140 | topon.n14.amf2.nodes.$ORIGIN. |

The first record in Table 2 is an AAAA record that returns a 128-bit IPv6 address. “2001:db3:1:27” is the external IP address of AMF4 which is mapped by CPE4 from the internal IP address of AMF4. The second record in Table 2 is an A record that returns a 32-bit IPv4 address. “192.0.2.140” is the external IP address of AMF2 which is mapped by CPE2 from the internal IP address of AMF2.

Now reference is made to FIG. 9 which shows the method corresponding to the above second option. At block 902, the management server obtains first topology information about the topology of the network at a first time. At block 903, the management server obtains second topology information about the topology of the network at a subsequent second time. There is a change between the two topologies of the network. The change may be caused by one or more of: a maritime vessel disconnects from the network due to mobility or breakdown (e.g. crash) of the maritime vessel; and a maritime vessel connects to the network due to mobility or restoration of the maritime vessel. The details about obtaining the topology of the network have been described above with respect to block 702. As an example, the first time may be the time when the topology of the network is initially formed. The second time may be a time when the topology of the network is changed after the first time. As another example, both the first time and the second time may be the time when the topology of the network is changed after the topology of the network is initially formed.

At block 904, the management server determines service addressing configuration updates for the one or more target maritime vessels, based on the first and second topology information. The one or more target maritime vessels refer to maritime vessel(s) whose service addressing configuration(s) is changed due to the change between the two topologies of the network. For example, for each target maritime vessel, a first service addressing configuration may be determined for the target maritime vessel based on the first topology information. Similarly, a second service addressing configuration may be determined for the target maritime vessel based on the second topology information. Then, the difference between the first and second service addressing configurations may be determined as the service addressing configuration update for the target maritime vessel. The details about determining the service addressing configuration have been described above with respect to block 704. At block 906, the management server sends the service addressing configuration updates to the one or more target maritime vessels. For example, the service addressing configuration update for each target maritime vessel of the one or more target maritime vessels may be sent to the router at the target maritime vessel to be used by the service addressing component contained in the router.

For ease of explanation, the scenario shown in FIG. 8 is still taken as an example. Suppose the first time is the time when the topology of the network is initially formed. Thus, the first topology information (which is the same as the initial topology information at block 702) may be obtained at block 902. Also suppose V4 crashes and thus disconnects from the network. Then, the affected vessels V3, V2 and V1 may try to reestablish radio connections to the network. Suppose they all reconnect to the terrestrial network T0 via V7. Thus, at the second time when the topology of the network is re-organized after the first time, the connection relationship between respective maritime vessels is as follows: T0 is connected with V7 and V6; V7 is connected with V3, V2 and V1 respectively; V3 is connected with V2; and V2 is connected with V1. The second topology information representing the above connection relationship may be obtained at block 903.

Then, the service addressing configuration updates for the target maritime vessels V3, V2, V1, V7 and V6 may be determined based on the first and second topology information at block 904. Still take V3 as an example. The first service addressing configuration determined for V3 may be as shown in Table 1 as described above. The second service addressing configuration determined for V3 may be represented by the following Table 3.

TABLE 3
Service addressing configuration for V3 (for the second time)

| | | order | prefix | flags | Address | regexp replacement |
|---|---|---|---|---|---|---|
| IN | NAPTR | 30 | “a” | 1 | regiona6.amfi.5gc.cpe1.3gppnetwork.org | topoff.n14.amf1.nodes.$ORIGIN. |
| IN | NAPTR | 10 | “a” | 1 | regiona6.amfi.5gc.cpe7.3gppnetwork.org | topon.n14.amf7.nodes.$ORIGIN. |
| IN | NAPTR | 20 | “a” | 1 | regiona6.amfi.5gc.cpe2.3gppnetwork.org | topon.n14.amf2.nodes.$ORIGIN. |

Note that the first record corresponding to the service provided by the AMF on V1 may be an optional record. The “topoff” in this record indicates that V1 is not directly connected to the target maritime vessel V3 in the topology of the network. Then, the difference between the two service addressing configurations (i.e. the addition of the first two records of Table 3 (related to V1 and V7) and the deletion of the first record of Table 1 (related to V4)) may be determined as the service addressing configuration update for V3. Then, the service addressing configuration update may be provided to the service addressing component (e.g. a DNS server) on V3 at block 906.

Optionally, in response to a trigger event indicating that there is to be a change in the current topology of the network, the management server may predict the future topology of the network based on collected information about the network. The collected information about the network may include, but not limited to, the previous topology of the network, the previous or current anchor, positioning information (e.g. GNSS information) of respective maritime vessels, the number of hops from respective maritime vessels to the corresponding anchor, the latency of an echo packet between network functions on different maritime vessels, or the like. If two maritime vessels are predicted to be connected with each other with a certain probability, the management server may send a service discovery configuration to the two maritime vessels before a radio connection is established between the two maritime vessels. The service discovery configuration may comprise the addresses (e.g. FQDN addresses or IP related addresses) of the services available at the two maritime vessels such that the service(s) available at one vessel can be associated with the service(s) available at the other vessel.

Now reference is made to FIG. 10 which shows the method corresponding to the above third option. The third option relates to the configuration information for packet routing. As described above, it may be applicable to the case where the number of the one or more target maritime vessels is more than one. In this case, the configuration information for packet routing can allow a packet to be routed along a path of the more than one target maritime vessel to a different maritime vessel. At block 1002, the management server obtains third topology information about a part of the topology of the network. The part of the topology is formed by the path and the different maritime vessel. The more than one target maritime vessel may refer to the maritime vessels satisfying the following requirements: 1) one of these maritime vessels (which may be called the originating maritime vessel) needs to send a packet to the different maritime vessel; 2) according to the topology of the network, the packet can start from the originating maritime vessel to reach the different maritime vessel via the remaining ones of these maritime vessels. For example, the third topology information may be obtained in response to a case where CP and/or UP traffic has been transferred from an originating maritime vessel to a different maritime vessel via a corresponding anchor node for a predetermined number of times, but the quality metric (e.g. quality of service (QoS) or packet loss rate) associated with the transferring is worse than a predetermined target.

At block 1004, the management server determines packet routing rules for the more than one target maritime vessel based on the third topology information. For example, for the originating maritime vessel in the path (formed by the more than one target maritime vessel), the determined packet routing rule may specify that if a packet needs to be sent to the different maritime vessel, the packet should be forwarded to the next maritime vessel in the path. For any remaining maritime vessel in the path, the determined packet routing rule may specify that if the maritime vessel receives a packet whose source address belongs to the previous maritime vessel in the path, the packet should be forwarded to the next maritime vessel in the topology along the direction of the path. At block 1006, the management server sends the packet routing rules to the more than one target maritime vessel. For example, the packet routing rule determined for each target maritime vessel may be sent to the router on the target maritime vessel to be used for packet routing.

For case of explanation, the scenario shown in FIG. 8 is still taken as an example. Suppose the topology of the network is represented by the second topology information described above with respect to block 903. That is, the connection relationship between respective maritime vessels is as follows: T0 is connected with V7 and V6; V7 is connected with V3, V2 and V1 respectively; V3 is connected with V2; and V2 is connected with V1. Also suppose that V3 needs to send CP and/or UP traffic to V1 via the anchor T0 and the transferring via T0 has been performed for a predetermined number of times but the quality metric associated with the transferring is worse than a predetermined target. In response to this case, the management server may determine the third topology information about a part of the topology of the network at block 1002. The part of the topology is formed by: the path of the target maritime vessels V3 and V2; and the different maritime vessel V1. Then, packet routing rules for V3 and V2 may be determined based on the third topology information at block 1004. The packet routing rule determined for V3 may specify that if a packet needs to be sent to V1, the packet should be forwarded to the next maritime vessel V2 in the path. The packet routing rule determined for V2 may specify that if V2 receives a packet whose source address belongs to the previous maritime vessel V3 in the path, the packet should be forwarded to the next maritime vessel V1 in the topology along the direction of the path. Then, the packet routing rules for V3 and V2 may be sent to the DNSs on V3 and V2 respectively at block 1006.

According to the packet routing rules, the process of delivering a packet from the originating vessel V3 to the different vessel V1 may be as follows. Note that in this process, it is supposed that the packet is to be sent from AMF3 on V3 to AMF1 on V1. Firstly, AMF3 may send a request for retrieving the address of AMF1 to DNS3 on V3. DNS3 may output the FQDN address “regiona6.amfi.5gc.cpe1.3gppnetwork.org” to CPE3 on V3. CPE3 may have a DNS resolving component to output the IP address of AMF1 to AMF3. Then, the source address (i.e. the address of AMF3) and the destination address (i.e. the address of AMF1) may be encapsulated into a PDU by AMF3 and the PDU may be sent to CPE3. CPE3 may encapsulate the PDU into the packet to be sent out. The source address of the packet is set as the address of CPE3. Since V1 is not directly reachable from V3, the destination address of the packet can be set as the address of CPE2 according to the packet routing rule configured from T0 to V3. Then, the packet may be sent from CPE3 to CPE2. According to the destination address of the PDU contained in the packet, CPE2 knows that the packet is destined to AMF1. According to the packet routing rule configured from T0 to V2, CPE2 can encapsulate the PDU into a packet by setting the source address of the packet to the address of CPE2 and setting the destination address of the packet to CPE1, and then forward the packet to CPE1. According to the destination address of the PDU contained in the packet, CPE1 knows that the packet is destined to AMF1, and thus forwards the packet to AMF1.

In contrast, there may be another packet delivering mode in which transferring of CP and/or UP traffic is handled by the corresponding anchor. Still take the process of delivering a packet from AMF3 to AMF1 as an example. Firstly, AMF3 may obtain the IP address of AMF1 as described above. Then, the source address (i.e. the address of AMF3) and the destination address (i.e. the address of AMF1) may be encapsulated into a PDU by AMF3 and the PDU may be sent to CPE3. CPE3 may encapsulate the PDU into the packet to be sent out. The source address of the packet may be set as the address of AMF3 and the destination address of the packet may be set as the address of AMF1. Since V1 is not directly reachable from V3, CPE3 can send the packet to CPE7 according to a default packet routing rule specifying that the packet should be forwarded towards the anchor T0 (e.g. in uplink direction). According to the destination address of the PDU contained in the packet, CPE7 knows that the packet is destined to AMF1. Since V1 is directly reachable from V7, CPE7 can forward the packet to CPE1. According to the destination address of the PDU contained in the packet, CPE1 knows that the packet is destined to AMF1, and thus forwards the packet to AMF1. During this process, the source address and destination address of the packet remain unchanged. Note that AMF1 and AMF3 are merely used as exemplary examples for illustration purpose. The above delivering processes may be applied between any suitable network functions or network nodes.

By comparing the above two packet delivering modes, it can be seen that since V3 and V1 are far away from V7 but close to V2, the transferring via V2 by the configuration of packet routing rules can provide better quality metric than the transferring via the anchor T0.

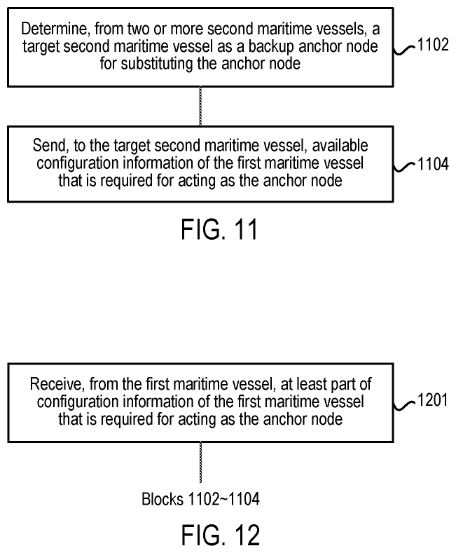

FIG. 11 is a flowchart illustrating a method performed by a management server according to an embodiment of the disclosure. For example, a server on land or on a fixed offshore platform may act as the management server. The method may be applicable to a network comprising a maritime network and a terrestrial network. The maritime network may comprise a first maritime vessel and two or more second maritime vessels. The first maritime vessel acts as an anchor node transferring CP traffic and/or UP traffic for the two or more second maritime vessels. At block 1102, the management server determines, from the two or more second maritime vessels, a target second maritime vessel as a backup anchor node for substituting the anchor node. For example, the second maritime vessel which is or can be provided with a core network (e.g. has sufficient computing resources to run instances of core network functions) and is closest to the land may be selected from the two or more second maritime vessels to act as the target second maritime vessel. As a first option, the target second maritime vessel may be determined when the first maritime vessel operates normally as the anchor node. As a second option, the target second maritime vessel may be determined in response to a trigger event indicating that the first maritime vessel has disconnected from the network. For example, the first maritime vessel may disconnect from the network due to mobility or breakdown (e.g. crash). Examples of the trigger event may include the receipt of various alarms or error reports due to link disconnection in IP layer (or layers below IP layer) or application layer.

At block 1104, the management server sends, to the target second maritime vessel, available configuration information of the first maritime vessel that is required for acting as the anchor node. For example, the available configuration information may comprise first configuration information for service addressing or packet routing that was previously provided to the first maritime vessel by the management server. Details of the first configuration information for service addressing or packet routing have been described above with respect to FIG. 6. With the method of FIG. 11, it is possible to facilitate the recovery of the network in a case where the anchor node disconnects from the network.

FIG. 12 is a flowchart illustrating a method performed by a management server according to an embodiment of the disclosure. As shown, the method of FIG. 12 comprises block 1201 and blocks 1102-1104 of FIG. 11. At block 1201, the management server receives, from the first maritime vessel, at least part of the configuration information of the first maritime vessel that is required for acting as the anchor node. For example, the configuration information may comprise: the first configuration information for service addressing or packet routing; and second configuration information related to subscribers served by the first maritime vessel (e.g. the subscription information between the relay terminal device and the terrestrial network). Block 1201 may be performed when the first maritime vessel operates normally as the anchor node.

At block 1102, the management server determines, from the two or more second maritime vessels, a target second maritime vessel as a backup anchor node for substituting the anchor node. At block 1104, the management server sends, to the target second maritime vessel, available configuration information of the first maritime vessel that is required for acting as the anchor node. The available configuration information may include: the first configuration information which is either received from the first maritime vessel or determined by the management server; and/or the second configuration information which is received from the first maritime vessel.

As an exemplary example, block 1102, block 1201 and block 1104 may be performed when the first maritime vessel operates normally as the anchor node. In this case, block 1201 and block 1104 may be performed at a predetermined time interval. As another exemplary example, block 1201 may be performed when the first maritime vessel operates normally as the anchor node, and blocks 1102-1104 may be performed in response to a trigger event indicating that the first maritime vessel has disconnected from the network. In this case, block 1201 may be performed at a predetermined time interval.

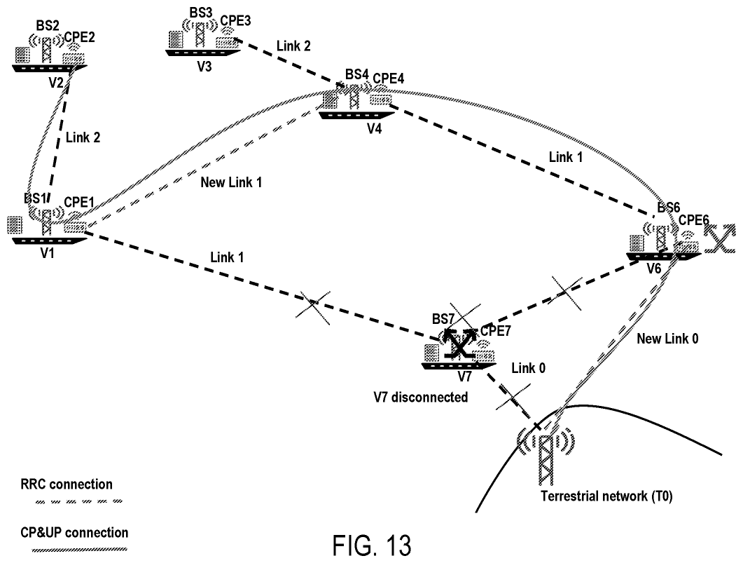

For ease of explanation, the scenario shown in FIG. 13 is taken as an example. In this scenario, suppose that V7 initially acts as the anchor node serving V1, V2, V3, V4 and V6, and the connection relationship between respective maritime vessels is as follows: T0 is connected with V7; V7 is connected with V1 and V6; V1 is connected with V2 and V6 is connected with V4; and V4 is connected with V3. When V7 operates normally, V6 may be determined as the backup node for substituting V7. Alternatively, V6 may be determined as the backup node in response to V7 disconnecting from the network. When V7 operates normally, V7 may provide its configuration information to T0 for backup.

Suppose V7 crashes and thus disconnects from the network. In response to this, T0 may send the latest configuration information of V7 to V6 so that V6 can act as the new anchor node. A new topology may be formed as follows: T0 is connected with V6; V6 is connected with V4; V4 is connected with V3 and V1; and V1 is connected with V2. Note that the methods of FIGS. 7 and 9 may also be performed in the scenario shown in FIG. 13. For example, when the new topology is formed, the management server in T0 may trigger service addressing configuration updates to corresponding affected vessels.

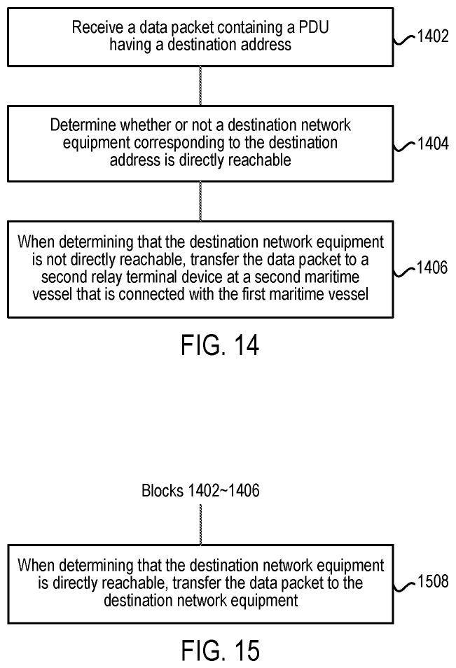

FIG. 14 is a flowchart illustrating a method performed by a first relay terminal device at a first maritime vessel according to an embodiment of the disclosure. At block 1402, the first relay terminal device receives a data packet containing a PDU having a destination address. The data packet may be an IP packet and the PDU may be a PDU of the application layer. As described above, there may be two delivering modes for a data packet. In the first delivering mode, the data packet is transferred according to packet routing rules configured from the management server. The source address and destination address of the data packet are changed during the transferring process while the source address and destination address of the PDU remain unchanged during the transferring process. In the second delivering mode, the transferring of the data packet is handled by a corresponding anchor. In the second delivering mode, the source address of the data packet remains the same as the source address of the PDU, and the destination address of the data packet remains the same as the destination address of the PDU.

At block 1404, the first relay terminal device determines whether or not a destination network equipment corresponding to the destination address is directly reachable. For example, if the destination network equipment corresponding to the destination address is the first relay terminal device or any other network equipment provided on the first maritime vessel, it may be determined that the destination network equipment is directly reachable. When determining that the destination network equipment is not directly reachable, the first relay terminal device transfers the data packet to a second relay terminal device at a second maritime vessel that is connected with the first maritime vessel at block 1406. For example, in the above first delivering mode, the second relay terminal device may be indicated in the packet routing rule configured from the management server. In the above second delivering mode, the second relay terminal device may be the relay terminal device on the next connected maritime vessel in the direction towards the corresponding anchor. With the method of FIG. 14, it is possible to facilitate inter-ship communication thereby improving service continuity for inter-ship traffic.

FIG. 15 is a flowchart illustrating a method performed by a first relay terminal device at a first maritime vessel according to an embodiment of the disclosure. As shown, the method comprises blocks 1402-1406 described above and block 1508. Blocks 1402-1406 have been described above and their details are omitted here. At block 1508, when determining that the destination network equipment is directly reachable, the first relay terminal device transfers the data packet to the destination network equipment. As described above, the router and the relay terminal device on a maritime vessel may work together to associate the internal IP address and port of a network equipment with an external IP address and port such that this network equipment can communicate with another maritime vessel by using the external IP address and port. Thus, when determining that the destination network equipment is directly reachable, the first relay terminal device may replace the external IP address and port of the data packet with the corresponding internal IP address and port and send the modified data packet to the network equipment such that the network equipment can know that the modified data packet is destined to it.

Optionally, in the methods of FIG. 14 and FIG. 15, the data packet may contain a CP message or a UP message. Examples of the CP message include, but not limited to, an N1 NAS message, an N2 next generation application protocol (NGAP) message, an Xn message, and a GPRS tunneling protocol version 2 control plane (GTPv2-C) message (e.g. defined in 3GPP TS 29.274). The UP message may be delivered between the following source and destination entities: between gNB and UPF; between eNB and SGW-U/PGW-U or combined; between SGW-U and PGW-U/UPF or combined; between gNBs/eNBs or combined; between SGWs/PGWs/UPFs or combined; between internal and external DNNs; between mesh servers. In the case of CP message, the data packet may contain one or more containers each of which comprises: a first indicator indicating a type of a CP message corresponding to the container; a second indicator indicating a length of contents of the container; and the contents of the container. In the case where the data packet contains multiple containers, the data packet may further contain one or more of: a third indicator indicating the number of the multiple containers; and a fourth indicator indicating the number of optional information elements.

As an exemplary example, the data packet may be an NGAP packet. Information about the IP layer of NGAP can be found from 3GPP technical specification (TS) 38.412. For example, the 5GC and NG-RAN shall support IPv6 (the Internet engineering task force (IETF) request for comments (RFC) 8200) and/or IPv4 (IETF RFC 791) or both. The IP layer of next generation core (NG-C) only supports point-to-point transmission for delivering NGAP message. There may be one or several IP addresses in the NG-RAN node and in the 5GC. The transport layer address signaled in NGAP messages is a bit string of: a) 32 bits in case of IPv4 address according to IETF RFC 791; or b) 128 bits in case of IPv6 address according to IETF RFC 8200; or c) 160 bits if both IPv4 and IPv6 addresses are signaled, in which case the IPv4 address is contained in the first 32 bits.

According to 3GPP TS 38.410, the NGAP signaling procedures may involve the following procedures when an NGAP CP message is triggered: PDU Session Management Procedure; UE Context Management Procedure; NAS transport procedure; UE Mobility Management Procedure; Paging procedure; AMF Management procedure; NG Interface Management procedure; Warning message transmission procedure; Location Reporting procedure; UE Radio Capability Management procedure; UE Tracing procedure; NR Positioning Protocol A (NRPPa) procedure; Overload Control procedure; Configuration Transfer procedure; Secondary radio access technology (RAT) Data Usage Report procedure; RAN information management (RIM) Information Transfer procedure; Retrieve UE Information procedure; RAN CP Relocation Indication procedure; UE Context Suspend procedure; Connection Establishment Indication procedure; AMF CP Relocation Indication procedure; etc.

As an exemplary example, the container may be a newly introduced container called Mesh signal container. The Mesh signal container information element may be used to transport one or multiple Mesh signal payloads both for uplink (UL) and downlink (DL). If multiple Mesh signal containers are transported, the associated information of each container may be also transported together with the container. The Mesh signal container may be a type 6 information element with a minimum length of 4 octets and a maximum length of 65538 octets. The structure of a general Mesh signal container information element may be as shown in Table 4 below. The structure of a Mesh signal container information element with Mesh signal container type “Multiple Container” may be as shown in Table 5 and Table 6 below.

TABLE 4
Mesh signal container information
element (general)

| | | | | | | | |
|---|---|---|---|---|---|---|---|
| 8 | 7 | 6 | 5 | 4 | 3 | 2 | 1 |

| | |
|---|---|
| Mesh signal container IEI | octet 1 |
| Length of Mesh signal container contents | octet 2 |
| | octet 3 |
| Mesh signal container contents | octet 4 |
| | octet n |

TABLE 5
Mesh signal container contents with Mesh
signal container type “Multiple Container”

| | | | | | | | |
|---|---|---|---|---|---|---|---|
| 8 | 7 | 6 | 5 | 4 | 3 | 2 | 1 |

| | |
|---|---|
| Number of entries | octet 4 |
| Mesh signal container entry 1 | octet 5 |
| | octet x2 |
| Mesh signal container entry 2 | octet x2 + 1 |
| | octet x3 |
| . . . | . . . |
| Mesh signal container entry i | octet xi + 1 |
| | octet n |

TABLE 6
Mesh signal container entry

| 8 | 7 | 6 | 5 | 4 | 3 | 2 | 1 | |
|---|---|---|---|---|---|---|---|---|
| Length of Mesh signal container entry | | | | | | | | octet xi + 1 |
| | | | | | | | | octet xi + 2 |
| Number of optional IEs | | | | Mesh signal container type | | | | octet xi + 3 |
| Mesh signal container entry contents | | | | | | | | octet xi + 4 |
| | | | | | | | | octet xj |

The Mesh signal container type information element may indicate the type of Mesh signal included in the Mesh signal container information element. For example, when a target node (e.g. AMF/MME/gNB/eNB) receives an UL NAS message with Mesh signal container, it may derive the message type according to content and container type. In particular, if the container type indicates that the message is an “N1 NAS Message”, resources may be preferentially allocated to the message by the base station. The Mesh signal container type may be a type 1 information element. For example, the Mesh signal container type information element may be coded as shown in Table 7 and Table 8 below.

TABLE 7
Mesh signal container type information element

| | | | | | | | |
|---|---|---|---|---|---|---|---|
| 8 | 7 | 6 | 5 | 4 | 3 | 2 | 1 |

| | | |
|---|---|---|
| Mesh signal container | Mesh signal container | octet 1 |
| type IE | type value | |

TABLE 8
Mesh signal container type information element
Mesh signal container type value (octet 1)
Bits

| 4 | 3 | 2 | 1 | |
|---|---|---|---|---|
| 0 | 0 | 0 | 1 | N1 NAS Message |
| 0 | 0 | 1 | 0 | N2 NGAP Message |
| 0 | 0 | 1 | 1 | Xn Message |
| 0 | 1 | 0 | 0 | GTPv2-C Message |
| 1 | 1 | 1 | 1 | Multiple Container |

All other values are reserved.

Therefore, the UL NAS TRANSPORT message content shown in Table 8.2.10.1.1 and the DL NAS TRANSPORT message content shown in Table 8.2.11.1.1 of 3GPP TS 24.501 are suggested to be modified as below, wherein the newly added contents are highlighted with underlines.

TABLE 9
(Table 8.2.11.1.1 of TS 24.501): UL NAS TRANSPORT message content

| IEI | Information Element | Type/Reference | Presence | Format | Length |
|---|---|---|---|---|---|
| | Extended protocol discriminator | Extended protocol discriminator | M | V | 1 |
| | | 9.2 | | | |
| | Security header type | Security header type | M | V | 1/2 |
| | | 9.3 | | | |
| | Spare half octet | Spare half octet | M | V | 1/2 |
| | | 9.5 | | | |
| | UL NAS TRANSPORT message | Message type | M | V | 1 |
| | identity | 9.7 | | | |
| | Payload container type | Payload container type | M | V | 1/2 |
| | | 9.11.3.40 | | | |
| | Spare half octet | Spare half octet | M | V | 1/2 |
| | | 9.5 | | | |
| | Payload container | Payload container | M | LV-E | 3-65537 |
| | | 9.11.3.39 | | | |
| 12 | PDU session ID | PDU session identity 2 | C | TV | 2 |
| | | 9.11.3.41 | | | |
| 59 | Old PDU session ID | PDU session identity 2 | O | TV | 2 |
| | | 9.11.3.41 | | | |
| 8 | Request type | Request type | O | TV | 1 |
| | | 9.11.3.47 | | | |
| 22 | S-NSSAI | S-NSSAI | O | TLV | 3-10 |
| | | 9.11.2.8 | | | |
| 25 | DNN | DNN | O | TLV | 3-102 |
| | | 9.11.2.1A | | | |
| 24 | Additional information | Additional information | O | TLV | 3-n |
| | | 9.11.2.1 | | | |
| X | Mesh signal container type | Spare half octet | O | V | 1/2 |
| XX | Mesh signal container | Mesh signal container | O | TLV | 3-65537 |

TABLE 10
(Table 8.2.11.1.1 of TS 24.501): DL NAS TRANSPORT message content

| IEI | Information Element | Type/Reference | Presence | Format | Length |
|---|---|---|---|---|---|
| | Extended protocol discriminator | Extended protocol discriminator | M | V | 1 |
| | | 9.2 | | | |
| | Security header type | Security header type | M | V | 1/2 |
| | | 9.3 | | | |
| | Spare half octet | Spare half octet | M | V | 1/2 |
| | | 9.5 | | | |
| | DL NAS TRANSPORT message | Message type | M | V | 1 |
| | identity | 9.7 | | | |
| | Payload container type | Payload container type | M | V | 1/2 |
| | | 9.11.3.40 | | | |
| | Spare half octet | Spare half octet | M | V | 1/2 |
| | | 9.5 | | | |
| | Payload container | Payload container | M | LV-E | 3-65537 |
| | | 9.11.3.39 | | | |
| 12 | PDU session ID | PDU session identity 2 | C | TV | 2 |
| | | 9.11.3.41 | | | |
| 24 | Additional information | Additional information | O | TLV | 3-n |
| | | 9.11.2.1 | | | |
| 58 | 5GMM cause | 5GMM cause | O | TV | 2 |
| | | 9.11.3.2 | | | |
| 37 | Back-off timer value | GPRS timer 3 | O | TLI | 3 |
| | | 9.11.2.5 | | | |
| Y | Mesh signal container type | Spare half octet | O | V | 1/2 |
| YY | Mesh signal container | Mesh signal container | O | TLV | 3-65537 |

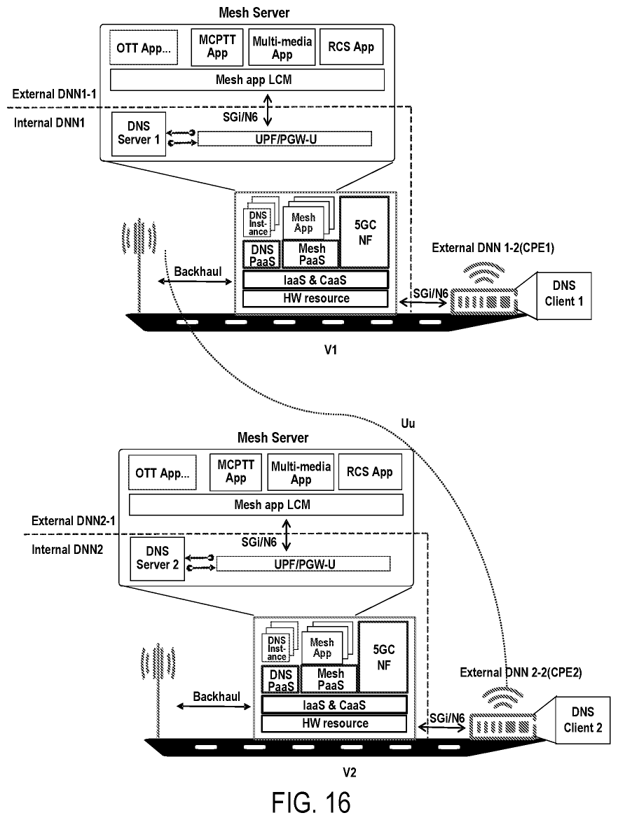

FIG. 16 is a diagram illustrating an exemplary configuration for a maritime network in which an embodiment of the disclosure is applicable. For illustration purpose, two maritime vessels V1 and V2 having the same configuration are shown. V1 has a base station, a core network implemented as 5GC, a DNS server implemented as DNS instance over DNS platform-as-a-service (PaaS), a mesh server implemented as mesh application over mesh PaaS, and a relay terminal device implemented as CPE1. Note that only the DNS server in application layer is shown in FIG. 16 and the router in IP layer is omitted in FIG. 16 for brevity. The DNS server, the mesh server and the 5GC are implemented over infrastructure-as-a-service (IaaS) and communications-as-a-Service (CaaS) by using hardware (HW) resource. CPE1 may have a DNS resolving component for resolving the FQDN address of a desired service to an IP related address. Thus, CPE1 may act as a DNS client. Over the mesh application life cycle management (LCM), various applications such as over the top (OTT) application, mission critical push to talk (MCPTT) application, multi-media application and rich communication services (RCS) application may be run.

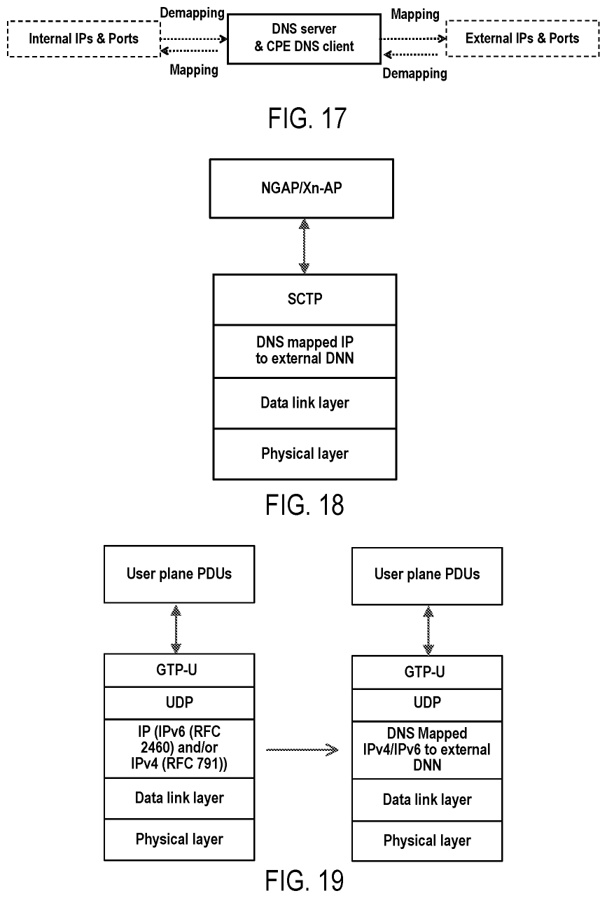

The base station, the DNS server and the 5GC may form an internal network. The internal IP addresses and ports of the base station and 5GC network functions (NFs) may be assigned by the DNS server. The mesh server and CPE1 may belong to the external network. The external IP addresses and ports of the mesh server and CPE1 may be assigned by the terrestrial network. As shown in FIG. 17, the DNS server and the CPE DNS client may work together to associate (or map) the internal IP addresses and ports of the base station and core NFs with corresponding external IP addresses and ports such that the base station and core NFs can communicate with another maritime vessel by using the external IP addresses and ports. On the other hand, the association between them may also be removed, which may be called demapping.

FIG. 18 is a diagram illustrating a control plane protocol stack usable in an embodiment of the disclosure. As shown, the control plane protocol stack comprises a physical layer, a data link layer, an IP layer, a stream control transmission protocol (SCTP) layer and an NGAP/Xn-application protocol (AP) layer. As described above, with the cooperation of the DNS server and the relay terminal device, the internal IP address and port in a data packet from a core network element may be mapped to and replaced with an external IP address and port in the IP layer which point to the external DNN. On the other hand, when a data packet is received from a different maritime vessel, the external IP address and port may be mapped to and replaced with an internal IP address and port in the IP layer.

FIG. 19 is a diagram illustrating a user plane protocol stack usable in an embodiment of the disclosure. As shown, the user plane protocol stack comprises a physical layer, a data link layer, an IP layer, a user datagram protocol (UDP) layer, and a GTP user plane (GTP-U) layer. As described above, with the cooperation of the DNS server and the relay terminal device, the internal IP address and port in a data packet from a core network element may be mapped to and replaced with an external IP address and port in the IP layer which point to the external DNN. On the other hand, when a data packet is received from a different maritime vessel, the external IP address and port may be mapped to and replaced with an internal IP address and port in the IP layer. Each of the DNS server and client at each hop may have at least DL and UL IP address & Port translation function. From the network side, the DNS function of mapping works as network address translation (NAT) for IPv4 and NAT64 & DNS64 for IPv6 (see IETF RFC 4787, RFC 5382, RFC 5508, RFC 6888). From the UE side, it also has bi-directional UP packet mapping and demapping both for the internal network and the external network.

For example, a transfer PDU (T-PDU), which is the payload tunneled in a GTP-U tunnel, may be provided and consumed by NFs. The T-PDU may be encapsulated in a GTP PDU by adding a GTP-U header and may be sent between GTP network nodes. The IP Source Address may be an IP address (& Port) of the source GTP-U entity from which the message is originating. The IP Destination Address may be an IP address (& Port) of the destination GTP-U entity. The DNS server may map the next hop GTP-U endpoint IP address & Port according to the local DNS configuration, wherein the destination address may be CPE/UE IP address & Port as an external DNN. The CPE/UE may take all external GTP-U packets as Mesh application PDUs such that the G-PDU may be delivered to the DNS server of the next hop. When the DNS server of the next hop receives the G-PDU, if the TEID of this hop does not match the TEID in the GTP-U header, the DNS server may further select the next hop DNS server according the TEID in the GTP-U Header. Thus, the previous hop DNS server may perform demapping and remapping to the next hop DNS/CPE/UE IP address & Port until the matching of endpoints occurs.

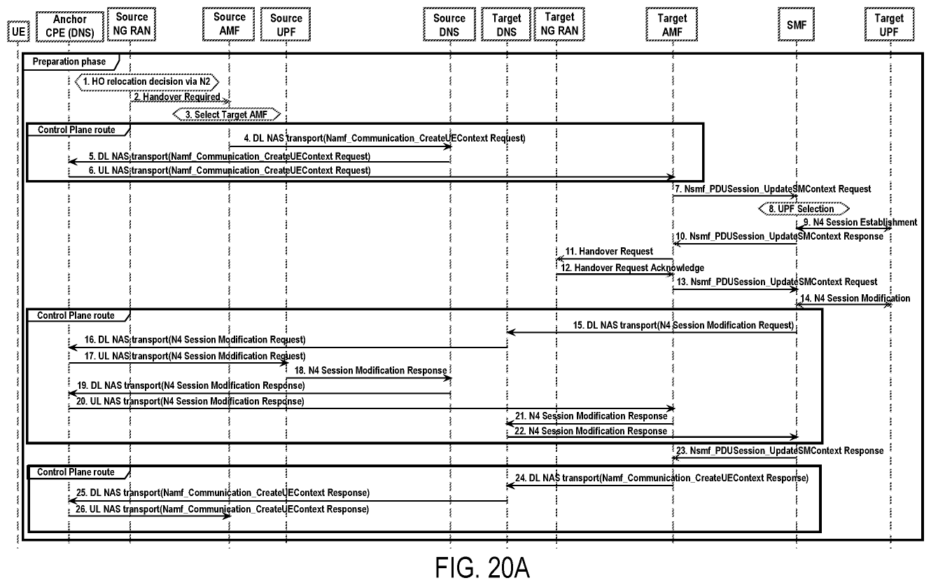

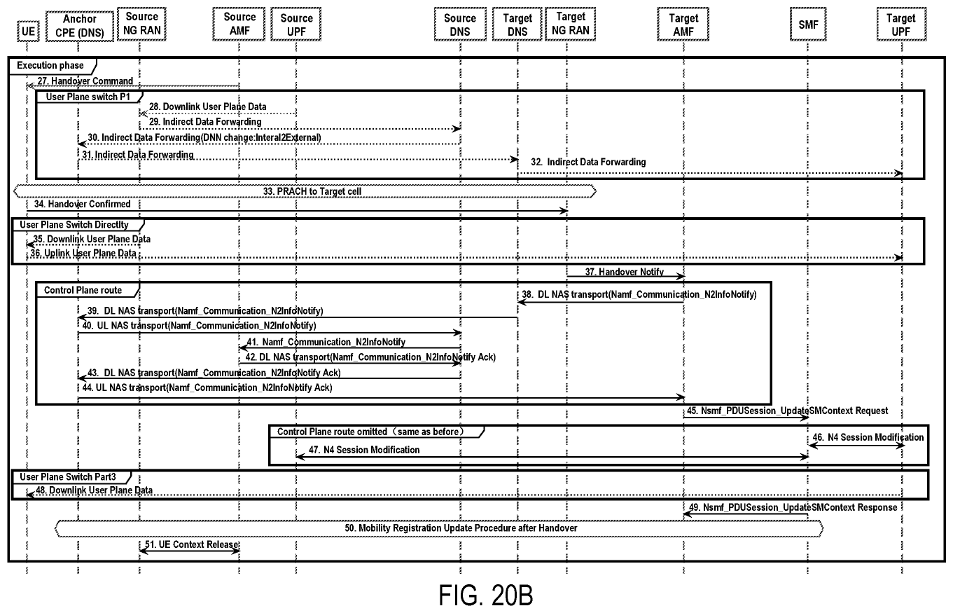

FIGS. 20A-20B are flowcharts illustrating an exemplary process according to an embodiment of the disclosure. As shown, this process involves a source vessel, a target vessel, a requesting vessel and an anchor vessel. Suppose that due to mobility, the UE on the requesting vessel needs to hand over from an RAN on the source vessel to an RAN on the target vessel. The source vessel is not directly connected with the target vessel. Thus, in the solution of the prior art, the UE has to disconnect from the source vessel and perform a new initial attach to the target vessel. In contrast, in this process, a handover can be performed between the source vessel and the target vessel via the anchor vessel such that service continuity can be supported thereby preventing direct disconnection of RRC. NAS and data packets. For example, suppose that in FIG. 8, V2 is initially connected with V3 and needs to hand over from V3 to V1 due to mobility. Then, V2 is the requesting vessel, V3 is the source vessel, V1 is the target vessel, and V7 is the anchor vessel. Although a typical N2 Handover is used as an example for explaining the service continuity both for CP and UP, the CP and UP flow are not limited to handover but can also be applied for all N1 NAS, N2 NGAP, GTP-C, GTP-U and Xn, Mesh and other OTT application protocol.

Note that the handover target cell (and the corresponding core network) may be selected based on signal strengths of neighboring cells, as defined in e.g. 3GPP protocols. Alternatively or additionally, one or more other factors, such as positioning information (e.g. GNSS information) of neighboring cells, chain information of neighboring cells, and the like, may be considered. The chain information of a neighboring cell may indicate the topology of the chain(s) from the neighboring cell to the corresponding anchor. For example, the RAN on the requesting vessel may collect the information of neighboring cells and prioritize the neighboring cells according to one or more of the above factors. If a neighboring cell has a better radio signal strength, or relative less hops (or shorter path switch) to the anchor, or a closer distance, the neighboring cell may be selected as the target cell. Then, the RAN on the requesting vessel may trigger a (e.g. X2-based or S1-based) handover as a result of the selecting procedure.

In the preparation phase of the handover process, at step 1, the source NG RAN makes a handover (HO) relocation decision via N2. At step 2, the source NG RAN sends a Handover Required message to the source AMF. At step 3, the source AMF selects a target AMF. Then, the source AMF needs to send, to the target AMF, an Namf_Communication_CreateUEContext Request. Thus, a control plane routing process is performed. Specifically, at step 4, the source AMF sends, to the source DNS, a DL NAS transport message containing Namf_Communication_CreateUEContext Request. Since the target AMF is not directly reachable from the source DNS, the source DNS sends, to the anchor CPE (DNS), a DL NAS transport message containing Namf_Communication_CreateUEContext Request at step 5. The anchor CPE (DNS) sends, to the target AMF via the target CPE, an UL NAS transport message containing Namf_Communication_CreateUEContext Request at step 6. The DL direction refers to the direction towards the anchor vessel and the UL direction refers to the direction away from the anchor vessel.

At step 7, the target AMF sends, to the SMF, an Nsmf_PDUSession_UpdateSMContext Request. At step 8, the SMF makes a UPF selection. At step 9, N4 Session Establishment is performed between the SMF and the target UPF. At step 10, the SMF sends, to the target AMF, an Nsmf_PDUSession_UpdateSMContext Response. At step 11, the target AMF sends a Handover Request message to the target NG RAN. At step 12, the target NG RAN sends a Handover Request Acknowledge message to the target AMF. At step 13, the target AMF sends, to the SMF, an Nsmf_PDUSession_UpdateSMContext Request. At step 14, N4 Session Modification is performed between the SMF and the target UPF.

Then, the SMF needs to send an N4 Session Modification Request to the source UPF and the source UPF needs to send an N4 Session Modification Response to the SMF. Thus, a control plane routing process is performed. Specifically, at step 15, the SMF sends, to the target DNS, a DL NAS transport message containing N4 Session Modification Request. At step 16, the target DNS sends, to the anchor CPE (DNS), a DL NAS transport message containing N4 Session Modification Request. At step 17, the anchor CPE (DNS) sends, to the source UPF via the source DNS, an UL NAS transport message containing N4 Session Modification Request. At step 18, the source UPF sends, to the source DNS, an N4 Session Modification Response. At step 19, the source DNS sends, to the anchor CPE (DNS), a DL NAS transport message containing N4 Session Modification Response. At step 20, the anchor CPE (DNS) sends, to the target AMF via the target DNS, an UL NAS transport message containing N4 Session Modification Response. At step 21, the target AMF sends, to the target DNS, an N4 Session Modification Response. At step 22, the target DNS sends, to the SMF, an N4 Session Modification Response.

At step 23, the SMF sends, to the target AMF. an Nsmf_PDUSession_UpdateSMContext Response. Then, the target AMF needs to send an Namf_Communication_CreateUEContext Response to the source AMF. Thus, a control plane routing process is performed. Specifically, at step 24, the Target AMF sends, to the target DNS, a DL NAS transport message containing Namf_Communication_CreateUEContext Response. At step 25, the Target DNS sends, to the anchor CPE (DNS), a DL NAS transport message containing Namf_Communication_CreateUEContext Response. At step 26, the anchor CPE (DNS) sends, to the source AMF via the source CPE, an UL NAS transport message containing Namf_Communication_CreateUEContext Response.

The process shown in FIG. 20B continues with the process shown in FIG. 20A. In the execution phase of the handover process, at step 27, the source AMF sends a Handover Command to the UE. Then, in the first part of the user plane switch, at step 28, the source UPF sends downlink User Plane data to the source NG RAN. At step 29, the source NG RAN performs indirect data forwarding to the source DNS. At step 30, the source DNS performs indirect data forwarding to the anchor CPE (DNS). The “Internal2External” shown at step 30 refers to that the internal IP address (and port) is replaced with the external IP address (and port). At step 31, the anchor CPE (DNS) performs indirect data forwarding to the target DNS. At step 32, the target DNS performs indirect data forwarding to the target UPF.

At step 33, the UE attempts physical random access channel (PRACH) to the target cell. At step 34, the UE sends a Handover Confirmed message to the target NG RAN. Then, in the second part of the user plane switch, at step 35, the source NG RAN sends downlink user plane data to the UE. At step 36, the UE sends uplink User Plane data to the target UPF.

At step 37, the target NG RAN sends a Handover Notify message to the target AMF. Then, the target AMF needs to send an Namf_Communication_N2InfoNotify to the source AMF. source and the AMF needs to send an Namf_Communication_N2InfoNotify Ack to the target AMF. Thus, a control plane routing process is performed. Specifically, at step 38, the target AMF sends, to the target DNS, a DL NAS transport message containing Namf_Communication_N2InfoNotify. At step 39, the target DNS sends, to the anchor CPE (DNS), a DL NAS transport message containing Namf_Communication_N2InfoNotify. At step 40, the anchor CPE (DNS) sends, to the source DNS, an UL NAS transport message containing Namf_Communication_N2InfoNotify. At step 41, the source DNS sends, to the source AMF, an Namf_Communication_N2InfoNotify. At step 42, the source AMF sends, to the source a DNS, DL NAS transport message containing Namf_Communication_N2InfoNotify Ack. At step 43, the source DNS sends, to the anchor CPE (DNS), a DL NAS transport message containing Namf_Communication_N2InfoNotify Ack. At step 44, the anchor CPE (DNS) sends, to the target AMF via the target CPE, an UL NAS transport message containing Namf_Communication_N2InfoNotify Ack.

At step 45, the target AMF sends, to the SMF, an Nsmf_PDUSession_UpdateSMContext Request. Then, in a control plane routing process, at step 46, N4 Session Modification is performed between the SMF and the target UPF. At step 47, N4 Session Modification is performed between the SMF and the source UPF. Note that some details of the control plane routing process are omitted for brevity. Then, in the third part of the user plane switch, at step 48, the target UPF sends downlink user plane data to the UE. At step 49, Mobility Registration Update Procedure is performed after the handover. At step 50, UE Context Release is performed between the source NG RAN and the source AMF.

Note that the carrier messages are not limited to UL NAS transport/DL NAS transport, but may also include: Service request/Service response; Control Plane Service request/Control Plane Service response; and Configuration update complete/Configuration update command. Also note that it is possible for the NF such as intermediate SMF (I-SMF) or intermediate UPF (I-UPF) to be involved in the maritime network for service continuity. The introduction of I-SMF and I-UPF can be found from 3GPP TS 23.501-g51 and TS 23.502-g51.

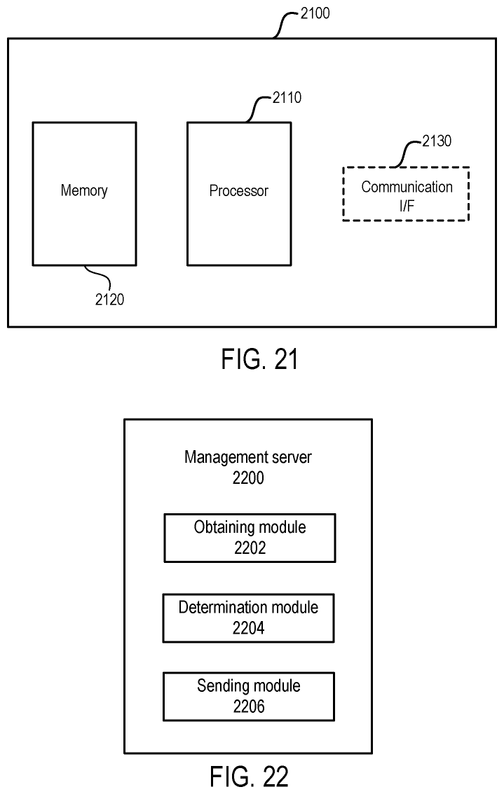

FIG. 21 is a block diagram showing an apparatus suitable for use in practicing some embodiments of the disclosure. For example, any one of the management server and the first relay terminal device described above may be implemented through the apparatus 2100. As shown, the apparatus 2100 may include a processor 2110, a memory 2120 that stores a program, and optionally a communication interface 2130 for communicating data with other external devices through wired and/or wireless communication.

The program includes program instructions that, when executed by the processor 2110, enable the apparatus 2100 to operate in accordance with the embodiments of the present disclosure, as discussed above. That is, the embodiments of the present disclosure may be implemented at least in part by computer software executable by the processor 2110, or by hardware, or by a combination of software and hardware.

The memory 2120 may be of any type suitable to the local technical environment and may be implemented using any suitable data storage technology, such as semiconductor based memory devices, flash memories, magnetic memory devices and systems, optical memory devices and systems, fixed memories and removable memories. The processor 2110 may be of any type suitable to the local technical environment, and may include one or more of general purpose computers, special purpose computers, microprocessors, digital signal processors (DSPs) and processors based on multi-core processor architectures, as non-limiting examples.

FIG. 22 is a block diagram showing a management server according to an embodiment of the disclosure. As shown, the management server 2200 comprises an obtaining module 2202, a determination module 2204 and a sending module 2206. The obtaining module 2202 may be configured to obtain topology information about at least part of a topology of a network comprising multiple maritime vessels, as described above with respect to block 602. The determination module 2204 may be configured to determine, for one or more target maritime vessels of the network, configuration information for service addressing or packet routing, based on the topology information, as described above with respect to block 604. The sending module 2206 may be configured to send the configuration information for service addressing or packet routing to the one or more target maritime vessels, as described above with respect to block 606.

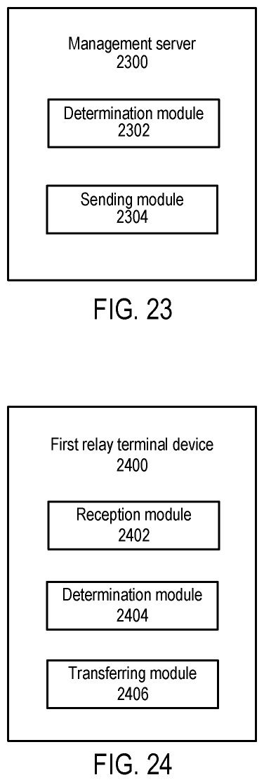

FIG. 23 is a block diagram showing a management server in a network according to an embodiment of the disclosure. The network comprises a first maritime vessel and two or more second maritime vessels. The first maritime vessel acts as an anchor node transferring CP traffic and/or UP traffic for the two or more second maritime vessels. As shown, the management server 2300 comprises a determination module 2302 and a sending module 2304. The determination module 2302 may be configured to determine, from the two or more second maritime vessels, a target second maritime vessel as a backup anchor node for substituting the anchor node, as described above with respect to block 1102. The sending module 2304 may be configured to send, to the target second maritime vessel, available configuration information of the first maritime vessel that is required for acting as the anchor node, as described above with respect to block 1104.

FIG. 24 is a block diagram showing a first relay terminal device at a first maritime vessel according to an embodiment of the disclosure. As shown, the first relay terminal device 2400 comprises a reception module 2402, a determination module 2404 and a transferring module 2406. The reception module 2402 may be configured to receive a data packet containing a PDU having a destination address, as described above with respect to block 1402. The determination module 2404 may be configured to determine whether or not a destination network equipment corresponding to the destination address is directly reachable, as described above with respect to block 1404. The transferring module 2406 may be configured to, when determining that the destination network equipment is not directly reachable, transfer the data packet to a second relay terminal device at a second maritime vessel that is connected with the first maritime vessel, as described above with respect to block 1406. The modules described above may be implemented by hardware, or software, or a combination of both.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/ or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a management server, comprising:
obtaining topology information about at least part of a topology of a network comprising multiple maritime vessels;
determining, for one or more target maritime vessels of the network, configuration information for service addressing or packet routing, based on the topology information; and
sending the configuration information for service addressing or packet routing to the one or more target maritime vessels.

2. The method according to claim 1, wherein the configuration information for service addressing can allow the one or more target maritime vessels to address services related to one or more different maritime vessels.

3. The method according to claim 2, wherein obtaining the topology information comprises:
obtaining initial topology information about the topology of the network when the topology of the network is initially formed;
wherein determining the configuration information for service addressing comprises:
determining service addressing configurations for the multiple maritime vessels based on the initial topology information; and
wherein the service addressing configurations are sent to the multiple maritime vessels.

4. The method according to claim 2, wherein obtaining the topology information comprises: obtaining first topology information about the topology of the network at a first time; and obtaining second topology information about the topology of the network at a subsequent second time, wherein there is a change between the two topologies of the network;
wherein determining the configuration information comprises: determining service addressing configuration updates for the one or more target maritime vessels, based on the first and second topology information; and
wherein the service addressing configuration updates are sent to the one or more target maritime vessels.

5. The method according to claim 4, wherein there is a change between the two topologies of the network because one or more of:
a maritime vessel disconnects from the network due to mobility or breakdown of the maritime vessel; and
a maritime vessel connects to the network due to mobility or restoration of the maritime vessel.

6. The method according to claim 2, wherein the configuration information for service addressing that can allow a target maritime vessel to address a service related to a different maritime vessel comprises:
a retrieval condition related to the different maritime vessel; and
an address of the service which corresponds to the retrieval condition.

7. The method according to claim 6, wherein the retrieval condition related to the different maritime vessel comprises:
identification information of a network equipment which provides the service and is located at or serves the different maritime vessel.

8. The method according to claim 7, wherein the retrieval condition related to the different maritime vessel further comprises one or more of:
an interface supported by the network equipment; and
an indicator indicating whether or not the different maritime vessel is directly connected to the target maritime vessel in the topology of the network.

9. The method according to claim 6, wherein the address of the service is an Internet protocol, IP, related address or a domain name address.

10. The method according to claim 9, wherein the domain name address comprises: identification information of a relay terminal device located on the different maritime vessel; and a type of a network equipment which provides the service.

11. The method according to claim 10, wherein the domain name address further comprises one or more of:
identification information of a maritime region where the different maritime vessel is located; and
identification information of a network standard supported by the network equipment.

12. The method according to claim 1, wherein the configuration information for service addressing takes a form of one or more domain name system, DNS, records.

13. The method according to claim 1, wherein a number of the one or more target maritime vessels is more than one, and the configuration information for packet routing can allow a packet to be routed along a path of the more than one target maritime vessel to a different maritime vessel.

14. The method according to claim 13, wherein obtaining the topology information comprises: obtaining third topology information about a part of the topology of the network, wherein the part of the topology is formed by the path and the different maritime vessel;
wherein determining the configuration information for packet routing comprises: determining packet routing rules for the more than one target maritime vessel based on the third topology information; and
wherein the packet routing rules are sent to the more than one target maritime vessel.

15. The method according to claim 1, wherein the multiple maritime vessels comprise: a first set of maritime vessels each of which is provided with core network nodes; and a second set of maritime vessels each of which is provided with no core network nodes; and
wherein control plane, CP, traffic and user plane, UP, traffic to/from the second set of maritime vessels are transferred by one or more anchor nodes in the first set of maritime vessels.

16. The method according to claim 15, wherein the CP traffic and the UP traffic to/from the second set of maritime vessels are transferred by the same anchor node in the first set of maritime vessels.

17. The method according to claim 15, wherein the CP traffic and the UP traffic to/from the second set of maritime vessels are transferred by different anchor nodes in the first set of maritime vessels.

18. A method performed by a management server in a network, wherein the network comprises a first maritime vessel and two or more second maritime vessels, and the first maritime vessel acts as an anchor node transferring control plane, CP, traffic and/or user plane, UP, traffic for the two or more second maritime vessels, the method comprising:
determining, from the two or more second maritime vessels, a target second maritime vessel as a backup anchor node for substituting the anchor node; and
sending, to the target second maritime vessel, available configuration information of the first maritime vessel that is required for acting as the anchor node.

19. The method according to claim 18, further comprising:
receiving, from the first maritime vessel, at least part of the configuration information of the first maritime vessel that is required for acting as the anchor node.

20-25. (canceled)

26. A method performed by a first relay terminal device at a first maritime vessel, comprising:
receiving a data packet containing a protocol data unit, PDU, having a destination address;
determining whether or not a destination network equipment corresponding to the destination address is directly reachable; and
when determining that the destination network equipment is not directly reachable, transferring the data packet to a second relay terminal device at a second maritime vessel that is connected with the first maritime vessel.

27-38. (canceled)
